(19) United States
(12) Patent Application Publication
(10) Pub. No.: US 2016/0357122 A1
(43) Pub. Date: Dec. 8, 2016

(54) ELECTROSTATIC CHARGE IMAGE DEVELOPING TONER

(71) Applicant: Konica Minolta, Inc., Tokyo (JP)

(72) Inventors: Junya ONISHI, Tokyo (JP); Tatsuya FUJISAKI, Tokyo (JP); Hidehito HARUKI, Asaka-shi (JP); Junichi FURUKAWA, Tokyo (JP); Shiro HIRANO, Tokyo (JP)

(21) Appl. No.: 15/171,658

(22) Filed: Jun. 2, 2016

(30) Foreign Application Priority Data
Jun. 4, 2015 (JP) 2015-114247

(51) Int. Cl. G03G 9/087; G03G 9/08

(52) U.S. Cl. CPC G03G 9/08755; G03G 9/08728; G03G 9/0819; G03G 9/0827; G03G 9/0804

(57) ABSTRACT

Provided is an electrostatic charge image developing toner which is capable of forming high-quality images for a long time period.

An electrostatic charge image developing toner, including at least a binder resin, a colorant, and a mold release agent, wherein a coefficient of variation of volume particle size distribution of the toner particles is 18% or less, and in a particle shape distribution analysis made using a flow type particle image analyzer, when an equivalent circle average particle diameter of the toner particles is designated as D (μm), an average aspect ratio of toner particles having an equivalent circle particle diameter in the range of (D−3) to (D−2) (μm) is designated as AR(L), and an average aspect ratio of toner particles having an equivalent circle particle diameter in the range of (D+3) to (D+4) (μm) is designated as AR(H), the relationship represented by the following Expression (1) is satisfied.

[Expression 1]

0.110≦AR(L)−AR(H)≦0.250 (1)

### CROSS-REFERENCE TO RELATED APPLICATION

This application is based on Japanese Patent Application No. 2015-114247 filed on Jun. 4, 2015, the contents of which are incorporated herein by reference.

### BACKGROUND

1. Technical Field

The present invention relates to an electrostatic charge image developing toner used for forming images by an electrophotographic system.

2. Description of Related Art

In recent years, in the field of electrostatic charge image developing toner (hereinafter, simply referred to as “toner”), the development of electrophotographic apparatuses suitable for the demand of the market and the development of toners that can be used for these apparatuses, are in a rapid progress.

For example, from the viewpoint of improving the image quality, particle diameter reduction of toner is in progress. Furthermore, from the viewpoint of productivity enhancement, speed improvement is in progress. Generally, when the particle diameter of a toner is decreased, the physical adhesive force increases, and when the electric charge amount is increased, the electrostatic adhesive force also increases. Accordingly, deterioration of developability or transferability occurs, and particularly, decrease in the image quality (granularity) in halftone images causes a problem. In this case, the electric charge amount distribution can be made sharper by making the particle size distribution of the toner sharper, and then, uniformity in the developability and transferability is enhanced. However, it is still difficult to completely eliminate the particle size distribution, and it is difficult to control the developability and transferability perfectly uniformly.

In order to solve such a problem, for example, Japanese Patent Application Laid-Open No. 2014-071333 discloses a technology of controlling the average aspect ratio of toner particles having a small particle diameter to a predetermined range, and controlling the difference in the aspect ratio of toner particles having different particle diameters in a toner to be a small value at or below a certain level. It has been reported that in this way, fluidity of toner is improved, dropouts do not easily occur when a toner image is transferred from a latent image support, and defective images attributable to the slippage of a transfer residual toner at the time of cleaning are not likely to occur.

However, particularly in recent years, there is a demand for uniformity in developing and transfer at a higher level than the current situation, along with the change in the market pursuing improvements in the image quality, reliability and speed, and thus an improvement is demanded. When the uniformity in developing and transfer is low, selective developing is likely to occur in a particular print mode, particularly in a case where images with a low print ratio are printed out. Furthermore, on the occasion of continuous use for a long time period, uniformity in developing and transfer is further deteriorated, and deterioration of the image quality occurs. It was found from the technology described in Japanese Patent Application Laid-Open No. 2014-071333 that when printing is performed continuously for a long time period, it is difficult to maintain excellent image quality.

Thus, it is an object of the present invention to provide an electrostatic charge image developing toner which is capable of forming images of high image quality for a long time period.

### SUMMARY

The inventors of the present invention conducted a thorough investigation in order to solve the problems described above, and as a result, the inventors found that the object of the present invention can be achieved by the configurations described below.

That is, the problem to be solved by the present invention is solved by the following means.

1. An electrostatic charge image developing toner, including at least a binder resin, a colorant, and a mold release agent,

wherein a coefficient of variation of volume particle size distribution of the toner particles is 18% or less, and

in a particle shape distribution analysis made using a flow type particle image analyzer,

when an equivalent circle average particle diameter of the toner particles is designated as D (μm), an average aspect ratio of toner particles having an equivalent circle particle diameter in the range of (D−3) to (D−2) (μm) is designated as AR (L), and an average aspect ratio of toner particles having an equivalent circle particle diameter in the range of (D+3) to (D+4) (μm) is designated as AR(H), the relationship represented by the following Expression (1) is satisfied.

[Expression 1]

0.110≦AR(L)−AR(H)≦0.250 (1)

2. The electrostatic charge image developing toner according to 1, wherein the binder resin includes a crystalline polyester resin.
3. The electrostatic charge image developing toner according to 1 or 2, wherein the coefficient of variation of volume particle size distribution of the toner particles is 15% to 18%.
4. The electrostatic charge image developing toner according to any one of 1 to 3, wherein the binder resin includes a styrene-acrylic resin.
5. The electrostatic charge image developing toner according to any one of 1 to 4, wherein the toner particles further contain silica particles produced by a sol-gel method as an external additive, and a number averaged primary particle diameter of the silica particles is 70 nm to 200 nm.
6. The electrostatic charge image developing toner according to any one of 1 to 5, wherein the relationship represented by the following Expression (2) is satisfied:

[Expression 2]

0.150≦AR(L)−AR(H)≦0.215 (2)

7. The electrostatic charge image developing toner according to any one of 1 to 6, wherein the equivalent circle average particle diameter of the toner particles is from 5 μm to 8 μm.
8. The electrostatic charge image developing toner according to any one of 1 to 7, wherein an average circularity of the toner particles is 0.970 or higher.
9. The electrostatic charge image developing toner according to any one of 1 to 8, wherein the binder resin includes an amorphous polyester resin.
10. The electrostatic charge image developing toner according to any one of 1 to 9, wherein the binder resin includes a hybrid amorphous polyester resin modified by a styrene-acrylic resin.
11. The electrostatic charge image developing toner according to any one of 1 to 10, wherein the binder resin includes a crystalline polyester resin at a proportion of from 1% by mass to 20% by mass in the binder resin components.
12. A method for producing an electrostatic charge image developing toner, including subjecting at least a binder resin fine particle dispersion containing a binder resin and a colorant particle dispersion containing a colorant, to aggregation and fusion in an aqueous medium in the presence of a sodium alkyl diphenyl ether disulfonate.
13. The method for producing an electrostatic charge image developing toner according to 12, wherein the sodium alkyl diphenyl ether disulfonate is sodium dodecyl diphenyl ether disulfonate or sodium nonyl diphenyl ether disulfonate.
14. The method for producing an electrostatic charge image developing toner according to 12, wherein at least the binder resin fine particle dispersion containing a binder resin and the colorant particle dispersion containing a colorant are subjected to aggregation and fusion in the aqueous medium in the presence of the sodium alkyl diphenyl ether disulfonate in an amount converted to a solid content of from 0.2% by mass to 1.8% by mass relative to 100% by mass of the total amount of the binder resin.
15. The method for producing an electrostatic charge image developing toner according to 12, wherein at least the binder resin fine particle dispersion containing a binder resin and the colorant particle dispersion containing a colorant are subjected to aggregation and fusion in the aqueous medium in the presence of the sodium alkyl diphenyl ether disulfonate in an amount converted to a solid content of from 0.5% by mass to 1.5% by mass relative to 100% by mass of the total amount of the binder resin.

### DETAILED DESCRIPTION

According to an embodiment of the present invention, there is provided an electrostatic charge image developing toner containing at least a binder resin, a colorant, and a mold release agent, wherein a coefficient of variation of volume particle size distribution of the toner particles is 18% or less, and in a particle shape distribution analysis made using a flow type particle image analyzer, when an equivalent circle average particle diameter of the toner particles is designated as D (μm), an average aspect ratio of toner particles having an equivalent circle particle diameter in the range of (D−3) to (D−2) (μm) is designated as AR(L), and an average aspect ratio of toner particles having an equivalent circle particle diameter in the range of (D+3) to (D+4) (μm) is designated as AR(H), the relationship represented by the following Expression (1) is satisfied.

[Expression 1]

0.110≦AR(L)−AR(H)≦0.250 (1)

When the electrostatic charge image developing toner of the present invention is used, images of high quality can be formed for a long time period.

According to the present invention, for an electrostatic charge image developing toner containing a binder resin, a colorant and a mold release agent, the particle size distribution of toner particles as well as the shape distribution of toner particles are precisely controlled.

Since small particle diameter components of toner particles have relatively high electric chargeability and strong electrostatic adhesive force, the small particle diameter components can weaken the physical adhesive force as a result of increasing the aspect ratio (approaching 1). Since large particle diameter components of toner particles have relatively low electric chargeability and weak electrostatic adhesive force, the large particle diameter components increase the physical adhesive force as a result of lowering the aspect ratio. That is, by controlling the aspect ratio as defined by the Expression (1) described above, the overall adhesive force distribution of the particle size distribution of toner particles can be made uniform, and the distribution of developability and transferability can be made uniform. In addition, when selective developing is suppressed, and the uniformity of transferability is enhanced, images of high quality can be obtained for a long time period.

Particularly, in the case of a toner containing a crystalline polyester as a binder resin, even at the time of long-term use in a low print ratio mode, excessive charging of the toner can be suppressed, the effect of suppressing selective developability is very high, and images of high quality can be obtained for a long time period.

Hereinafter, the configuration of the present invention will be explained.

(Electrostatic Charge Image Developing Toner)

The toner according to the present embodiment is configured to include at least a binder resin, a colorant, and a mold release agent. Furthermore, the toner may additionally include other internal additives and external additives, if necessary. The volume averaged particle diameter and the coefficient of variation of volume particle size distribution of toner particles, and the equivalent circle particle diameter and the average aspect ratio obtainable by a particle shape distribution analysis using a flow type particle image analyzer, do not vary depending on the presence or absence of the addition of these internal additives and external additives.

(1) Volume Averaged Particle Diameter and Coefficient of Variation of Volume Particle Size Distribution of Toner Particles

In regard to the toner of the present embodiment, since it is preferable to use a small particle diameter toner that is required for high image quality, the volume averaged particle diameter of the toner particles is preferably 4 μm to 10 μm, and more preferably 5 μm to 8 μm. When the volume averaged particle diameter of the toner particles is 4 μm or more, deterioration of fluidity will not occur, and therefore, it is preferable from the viewpoint that managing (operability, handleability, and the like) in an electrophotographic process can be easily implemented. Furthermore, the volume averaged particle diameter of the toner particles is 10 μm or less, the surface area of toner particles that are in contact is not decreased, and therefore, the toner can be used as the small particle diameter toner required for image quality improvement.

Regarding the volume averaged particle diameter of the toner particles, for example, in a case where the toner particles are produced by employing the emulsification aggregation method described below, the volume averaged particle diameter can be controlled by the concentration of the aggregating agent used, the amount of addition of an organic solvent, a fusion time, and the composition of the polymer. When the volume averaged particle diameter of the toner particles is in the range described above, very fine dot images at a level of 1200 dpi (dpi: number of dots per inch (2.54 cm)), for example, can be reliably reproduced.

According to the present embodiment, the coefficient of variation of volume particle size distribution of the toner particles (coefficient of variation of volume-based particle diameter) is 18% or less. In the present specification, the coefficient of variation of volume particle size distribution of the toner particles is represented by the expression: ((standard deviation of volume averaged particle diameter)/(volume averaged particle diameter))×100(%). If the coefficient of variation of volume particle size distribution of the toner particles is more than 18%, the electric charge amount of the toner particles becomes non-uniform, and non-uniformity in developability and transferability may occur. The lower limit of the coefficient of variation of volume particle size distribution of the toner particles is not particularly limited; however, the coefficient of variation is preferably 15% or more. When the coefficient of variation of volume particle size distribution of the toner particles is 15% or more, it is preferable because the toner has excellent fluidity, and high developability and transferability are obtained.

The volume averaged particle diameter of the toner particles can be adjusted by, for example, controlling the particle diameter growth of aggregate particles in connection with the method for obtaining a toner by an emulsification aggregation method. Furthermore, the coefficient of variation of volume particle size distribution can be controlled, in a case where heating is performed in an aggregation and fusion process, by regulating the speed of temperature increase, the time for leaving to stand after heating, and the like. For example, when the speed of temperature increase is slowed, and the time for leaving to stand after heating is prolonged, the coefficient of variation of volume particle size distribution tends to decrease.

In the present specification, regarding the volume averaged particle diameter and the coefficient of variation of volume particle size distribution of the toner particles, values measured by the methods described in the Examples given below will be employed.

(2) Average Aspect Ratio of Toner Particles

In regard to the toner of the present embodiment, for the small particle diameter components in the particle size distribution of toner particles, the aspect ratio is made relatively high, the surface area is suppressed, and the electrostatic adhesive force is suppressed. For the large particle diameter components, the aspect ratio is made relatively low, the surface area is increased, the electrostatic adhesive force is increased, and the electrostatic adhesive force is made uniform over the entire particle size distribution.

From such a viewpoint, in regard to the toner of the present embodiment, when the equivalent circle average particle diameter of the toner particles is designated as D (μm), the average aspect ratio AR(L) of toner particles having an equivalent circle particle diameter in the range of (D−3) to (D−2) (μm) (small particle diameter components) is preferably 0.870 to 0.970, and more preferably 0.890 to 0.950. When the average aspect ratio AR(L) is in the range described above, a toner which satisfies the Expression (1) described above can be suitably obtained.

Furthermore, the average aspect ratio AR(H) of toner particles having an equivalent circle particle diameter in the range of (D+3) to (D+4) (μm) (large particle diameter components) is preferably 0.680 to 0.850, and more preferably 0.700 to 0.830. When the average aspect ratio is in the range described above, a toner which satisfies the Expression (1) described above can be suitably obtained.

In regard to the toner of the present invention, the difference of the average aspect ratios represented by the Expression (1) described above, AR(L)−AR(H), is 0.110 to 0.250. In a case where the value of AR(L)−AR(H) is smaller than 0.110, or in a case where the value is larger than 0.250, it is difficult to make the electrostatic adhesive force even over the entire particle size distribution. Therefore, on the occasion of continuous use for a long time, deterioration of the image quality occurs. The value of AR(L)−AR(H) is preferably 0.150 to 0.230, and more preferably 0.150 to 0.215.

Regarding the value of the difference of the average aspect ratios, AR(L)−AR(H), represented by Expression (1), in a case where a method of obtaining a toner through an emulsification aggregation method is used, the particle size distribution at the time point of initiating the particle diameter growth can be regulated by controlling the particle size distribution and the aspect ratio distribution. The particle size distribution and the aspect ratio distribution at the time point of initiating particle diameter growth are reflected to the particle size distribution and the aspect ratio distribution of the toner particles that are finally obtained. Specifically, the aspect ratio distribution can be controlled by controlling the heating temperature, the rate of temperature increase, the amount of a surfactant to be added, and the like, in the aggregation/fusion process. For example, when a large amount of surfactant is used, particle aggregation occurs mildly, and the particle shape on the large particle diameter side of the particle size distribution approaches a spherical shape, and therefore, the overall aspect ratio distribution becomes smaller. When the amount of surfactant is reduced, rapid particle aggregation occurs, the shape on the large particle diameter side of the particle size distribution is distorted, and the overall aspect ratio distribution becomes larger.

The equivalent circle average particle diameter D (μm) of the toner particles is not particularly limited; however, the equivalent circle average particle diameter is preferably from 5 μm to 8 μm. When the equivalent circle average particle diameter is in the range described above, the effects of the present invention may be obtained more noticeably.

In the present specification, regarding the values of the equivalent circle average particle diameter and the average aspect ratio of the toner particles, the values measured by the method described in the following Examples are to be employed.

(3) Average Circularity of Toner Particles

The toner of the present embodiment is such that the average circularity of the toner particles is preferably 0.970 or more. When the average circularity of the toner particles is 0.970 or more, a toner which satisfies the relationship of Expression (1) described above can be suitably obtained. In the present specification, regarding the value of the average circularity of the toner particles, the value measured by the method described in the following Examples is to be employed.

(Binder Resin)

Regarding the binder resin, any conventionally known binder resin that is used in toners can be used. Specific examples thereof include polyester resins; polymers of styrene or substitution products thereof, such as polyvinyltoluene; styrene-based copolymers such as a styrene-p-chlorostyrene copolymer, a styrene-propylene copolymer, a styrene-vinyltoluene copolymer, a styrene-vinylnaphthalene copolymer, a styrene-methyl acrylate copolymer, a styrene-ethyl acrylate copolymer, a styrene-butyl acrylate copolymer, a styrene-octyl acrylate copolymer, a styrene-methyl methacrylate copolymer, a styrene-ethyl methacrylate copolymer, a styrene-butyl methacrylate copolymer, a styrene-methyl α-chloromethacrylate copolymer, a styrene-acrylonitrile copolymer, a styrene-vinyl methyl ketone copolymer, a styrene-butadiene copolymer, a styrene-isoprene copolymer, a styrene-acrylonitrile-indene copolymer, a styrene-maleic acid copolymer, and a styrene-maleic acid ester copolymer; polymethyl methacrylate, polybutyl methacrylate, polyvinyl chloride, polyvinyl acetate, polyethylene, polypropylene, an epoxy resin, an epoxy polyol resin, polyurethane, polyamide, polyvinyl butyral, a polyacrylic acid resin, rosin, a modified rosin, a terpene resin, an aliphatic or alicyclic hydrocarbon resin, and an aromatic petroleum resin.

From the viewpoint of enhancing the low temperature fixability, with which a toner image is fixed at a lower temperature, it is preferable that the toner of the present embodiment contains a polyester resin as a binder resin. Preferably, the toner of the present embodiment contains a crystalline polyester resin as a binder resin. When the toner contains a crystalline polyester resin, low temperature fixability can be further enhanced. Also, from the viewpoints of the low temperature fixability and the heat-resistant preservability of the toner, it is preferable to use a crystalline polyester resin and an amorphous resin in combination as the binder resin, and it is more preferable to use a crystalline polyester resin and an amorphous polyester resin in combination.

<Crystalline Polyester Resin>

A crystalline polyester resin refers to a resin, among known polyester resins each obtainable by a polycondensation reaction of a divalent or higher-valent carboxylic acid (polyvalent carboxylic acid) and a dihydric or higher-hydric alcohol (polyhydric alcohol), which has not a stepwise endothermic change but a clear endothermic peak in differential scanning calorimetry (DSC). A clear endothermic peak specifically means a peak for which, when measurement is made at a rate of temperature increase of 10° C./min in the differential scanning calorimetry (DSC) described in the Examples, the half-value width of the endothermic peak is 15° C. or less.

The crystalline polyester resin is not particularly limited as long as the crystalline polyester resin is defined above, and for example, for any resin having a structure in which another component is copolymerized into the main chain based on a crystalline polyester resin, if this resin exhibits a clear endothermic peak as described above, the resin corresponds to the crystalline polyester resin defined by the present invention.

The weight average molecular weight (Mw) of the crystalline polyester resin is preferably 5,000 to 40,000. When the weight average molecular weight is in such a range, the toner particles thus obtainable do not become particles having a low melting point as a whole, and the toner has excellent blocking resistance and excellent low temperature fixability. The weight average molecular weight can be measured by gel permeation chromatography (GPC).

The melting point (Tm) of the crystalline polyester resin is preferably 50° C. or higher and lower than 120° C., and more preferably 60° C. or higher and lower than 90° C. When the melting point of the crystalline polyester resin is in the range described above, it is preferable because low temperature fixability and fixation separability are appropriately obtained. In regard to the melting point of the crystalline polyester resin, specifically, the endothermic peak temperature measured by the method described in the Examples is designated as the melting point of the crystalline polyester resin.

The acid value (AV) of the crystalline polyester resin is preferably 5 mg KOH/g to 70 mg KOH/g. The acid value can be measured according to the method described in JIS K2501:2003.

A crystalline polyester resin is produced from a polyvalent carboxylic acid component and a polyhydric alcohol component. The valences of the polyvalent carboxylic acid component and the polyhydric alcohol component are each preferably 2 to 3, and particularly preferably 2. Therefore, the case where the valences are respectively 2 (that is, a dicarboxylic acid component and a diol component) will be explained as a particularly preferred embodiment.

Regarding the dicarboxylic acid component, it is preferable to use an aliphatic dicarboxylic acid, and an aromatic dicarboxylic acid may be used in combination therewith. Regarding the aliphatic dicarboxylic acid, it is preferable to use a linear type aliphatic dicarboxylic acid. When a linear type aliphatic dicarboxylic acid is used, there is an advantage that crystallinity is increased. The dicarboxylic acid component is not limited to be used singly, and two or more kinds may be used as a mixture. Regarding the aliphatic dicarboxylic acid, it is more preferable to use a linear type aliphatic dicarboxylic acid having a main chain composed of 2 to 22 carbon atoms.

Examples of the aliphatic dicarboxylic acid include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid (1,10-dodecanedioic acid), 1,11-undecanedicarboxylic acid, 1,12-dodecanedicarboxylic acid, 1,13-tridecanedicarboxylic acid, 1,14-tetradecanedicarboxylic acid, 1,16-hexadecanedicarboxylic acid, and 1, 18-octadecanedicarboxylic acid. Also, lower alkyl esters and anhydrides of these acids can also be used.

Among the aliphatic dicarboxylic acids described above, from the viewpoint of easy availability, the aliphatic dicarboxylic acid is preferably a linear type aliphatic dicarboxylic acid having 6 to 14 carbon atoms, and is more preferably adipic acid, 1,8-octanedicarboxylic acid, 1,9-nonanedicarboxylic acid, or 1,10-decanedicarboxylic acid (1,10-dodecanedioic acid).

Examples of the aromatic dicarboxylic acid include terephthalic acid, isophthalic acid, ortho-phthalic acid, t-butylisophthalic acid, 2, 6-naphthalenedicarboxylic acid, and 4,4′-biphenyldicarboxylic acid. Among these, from the viewpoints of easy availability and easy emulsifiability, it is preferable to use terephthalic acid, isophthalic acid, or t-butylisophthalic acid.

The amount of use of the aliphatic dicarboxylic acid is preferably 80 composition mol % or more, more preferably 90 composition mol % or more, and even more preferably 100 composition mol %, when the total amount of the dicarboxylic acid component for forming the crystalline polyester resin is designated as 100 composition mol %. When the amount of use of the aliphatic dicarboxylic acid is 80 composition mol % or more, crystallinity of the crystalline polyester resin can be secured, and the toner thus produced acquires excellent low temperature fixability. Also, the image finally formed acquires glossiness, and also, deterioration of image preservability caused by lowered melting point is suppressed. Furthermore, when oil droplets are formed using an oil-phase liquid containing the crystalline polyester resin, the oil droplets can be reliably brought into an emulsified state.

Furthermore, regarding the diol component, it is preferable to use a saturated aliphatic diol, and if necessary, a diol other than a saturated aliphatic diol may also be incorporated. Regarding the diol component, it is more preferable to use, among the saturated aliphatic diols, a linear type saturated aliphatic diol having a main chain composed of 2 to 22 carbon atoms.

Examples of the saturated aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol. Among these, from the viewpoint of easy availability and from the viewpoint of exhibiting reliable low temperature fixability, a saturated aliphatic diol having a main chain composed of 2 to 14 carbon atoms is preferred.

Regarding the diol component, a branched type saturated aliphatic diol can also be used; however, in this case, from the viewpoint of securing crystallinity, it is preferable to use a branched type saturated aliphatic diol together with a linear type saturated aliphatic diol, and to use the relevant linear type saturated aliphatic diol at a higher proportion. When the saturated aliphatic diols are used by making the proportion of the linear type saturated aliphatic diol higher as such, crystallinity is secured, and the toner thus produced can reliably acquire excellent low temperature fixability. Also, for the images that are finally formed, deterioration of image preservability caused by lowered melting point is suppressed, and blocking resistance is reliably obtained.

The diol components may be used singly, or two or more kinds thereof may be used in combination.

Regarding the diol component for forming a crystalline polyester resin, it is preferable that the content of the saturated aliphatic diol is 80 composition mol % or more, more preferably 90 composition mol % or more, and even more preferably 100 composition mol %. When the content of the saturated aliphatic diol in the diol component is adjusted to 80 composition mol % or more, crystallinity of the crystalline polyester resin can be secured, the toner thus produced acquires excellent low temperature fixability, and also, images that are finally formed acquire glossiness.

Examples of a diol other than a saturated aliphatic diol include a diol having a double bond, and a diol having a sulfonic acid group. Specific examples of the diol having a double bond include 2-butene-1,4-diol, 3-butene-1,6-diol, and 4-butene-1,8-diol. It is preferable that the content of the diol having a double bond in the diol component is 20 composition mol % or less.

Meanwhile, if necessary, for the purpose of adjusting the acid value or the hydroxyl value, or the like, monovalent acids such as acetic acid and benzoic acid; monohydric alcohols such as cyclohexanol and benzyl alcohol; benzenetricarboxylic acid, naphthalenetricarboxylic acid and anhydrides and lower alkyl esters thereof; trihydric alcohols such as glycerin, trimethylolethane, trimethylolpropane, and pentaerythritol can also be used in combination.

The crystalline polyester resin can be synthesized at any arbitrary combinations of the constituent components described above, using a conventionally known method. A transesterification method, a direct polycondensation method, and the like can be used singly or in combination.

Specifically, condensation can be carried out at a polymerization temperature of from 140° C. to 270° C., and if necessary, the pressure inside the reaction system is decreased, and the reaction is performed while the water or alcohol generated at the time of condensation is eliminated. In a case where the monomers do not dissolve or are not compatible at the reaction temperature, a solvent having a high boiling point may be added to the system as a dissolution aid solvent to dissolve the monomers. The polycondensation reaction is carried out while distilling off the dissolution aid solvent. In a case where a monomer having poor compatibility for the copolymerization reaction is present, the monomer having poor compatibility is condensed in advance with the acid or alcohol which is expected to be subjected to polycondensation with that monomer, and then the resultant may be subjected to polycondensation together with main components.

The use ratio of the diol component and the dicarboxylic acid component described above is preferably adjusted such that the equivalent ratio of the hydroxyl groups [OH] of the diol component to the carboxyl groups [COOH] of the dicarboxylic acid component, [OH]/[COOH], is 1.5/1 to 1/1.5, and more preferably 1.2/1 to 1/1.2. When the use ratio of the diol component and the dicarboxylic acid component is in the range described above, a crystalline polyester resin having a desired molecular weight can be reliably obtained.

Examples of a catalyst that can be used at the time of production of the crystalline polyester resin include aliphatic titanium carboxylates, including aliphatic titanium monocarboxylates such as titanium acetate, titanium propionate, titanium hexanoate, and titanium octanoate; aliphatic titanium dicarboxylates such as titanium oxalate, titanium succinate, titanium maleate, titanium adipate, and titanium sebacate; aliphatic titanium tricarboxylates such as titanium hexanetricarboxylate and titanium isooctanetricarboxylate; and aliphatic titanium polycarboxylates such as titanium octanetetracarboxylate and titanium decanetetracarboxylate; aromatic titanium carboxylates, including aromatic titanium monocarboxylates such as titanium benzoate; aromatic titanium dicarboxylates such as titanium phthalate, titanium terephtahlate, titanium isophthalate, titanium naphthalenedicarboxylate, titanium biphenyldicarboxylate, and titanium anthracenedicarboxylate; aromatic titanium tricarboxylates such as titanium trimellitate and titanium naphthalenetricarboxylate; and aromatic titanium tetracarboxylates such as titanium benzenetetracarboxylate and titanium naphthalenetetracarboxylate; titanyl compounds of aliphatic titanium carboxylates or aromatic titanium carboxylates, and alkali metal salts thereof; titanium halides such as titanium dichloride, titanium trichloride, titanium tetrachloride, and titanium tetrabromide; tetraalkoxytitaniums such as tetrabutoxytitanium (titanium tetrabutoxide), tetraoctoxytitanium, and tetrastearyloxytitanium; and titanium-containing catalysts such as titanium acetylacetonate, titanium diisopropoxide bisacetylacetonate, and titanium triethanol aminate.

Furthermore, the crystalline polyester resin may be a hybrid crystalline polyester resin (hybrid resin), in which crystalline polyester resin units are chemically bonded to amorphous resin units other than a polyester resin. Since the resin component that constitutes the amorphous resin units is not particularly limited, and examples thereof include a vinyl resin unit, a urethane resin unit, and a urea resin unit. Among them, a vinyl resin unit is preferred, for the reason that thermoplasticity can be easily controlled.

The vinyl resin unit is not particularly limited as long as it is a product obtained by polymerizing a vinyl compound, and examples thereof include an acrylic acid ester resin unit, a styrene-acrylic acid ester resin unit (styrene-acrylic resin unit), and an ethylene-vinyl acetate resin unit.

The content of the crystalline polyester resin is preferably 1% to 20% by mass, and more preferably 5% to 20% by mass, relative to the total amount of the binder resin. When the content of the crystalline polyester resin is 20% by mass or less, embedding of external additives or filming occurs less. Furthermore, when the content is 1% by mass or more, the effect of enhancing low temperature fixability is effectively obtained.

<Amorphous Resin>

(Amorphous Polyester Resin)

It is preferable that the toner of the present embodiment contains an amorphous resin as a binder resin. The amorphous resin is not particularly limited; however, it is preferable that the toner contains an amorphous polyester resin obtained by condensing a polyhydric alcohol component and a polyvalent carboxylic acid component.

It is preferable that the content of the amorphous resin (particularly, an amorphous polyester resin) is adjusted to an amount of usually 50% to 95% by mass, and preferably 50% to 80% by mass, relative to the total amount (100% by mass) of the binder resin. When the content is in such a range, the toner thus obtainable has excellent blocking resistance, and low temperature fixability can also be obtained.

The amorphous polyester resin is a polyester resin other than the crystalline polyester resin described above. That is, the amorphous polyester resin is usually a resin which does not have a melting point but has a relatively high glass transition temperature (Tg). More specifically, the glass transition temperature (Tg) is preferably 40° C. to 90° C., and particularly preferably 45° C. to 80° C. Meanwhile, the glass transition temperature (Tg) is measured by the method described in the Examples.

The weight average molecular weight (Mw) of the amorphous resin is preferably 3,000 to 100,000, and more preferably 4,000 to 70,000. In a case where the weight average molecular weight (Mw) of the amorphous resin is in such a range, the toner thus obtainable has excellent blocking resistance, and low temperature fixability can also be obtained.

The polyhydric alcohol component is not particularly limited, and examples thereof include aliphatic diols such as ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-eicosanediol; bisphenols such as bisphenol A and bisphenol F; alkylene oxide adducts of bisphenols, such as ethylene oxide adducts and propylene oxide adducts of these bisphenols. Furthermore, examples of a trivalent or higher-valent polyhydric alcohol component include glycerin, trimethylolpropane, pentaerythritol, and sorbitol. Furthermore, from the viewpoints of the production cost and environmental issues, it is acceptable to use cyclohexanedimethanol, cyclohexanediol, and neopentyl alcohol. Furthermore, regarding the polyhydric alcohol component that can form an amorphous polyester resin, unsaturated polyhydric alcohols such as 2-butyne-1,4-diol, 3-butyne-1,4-diol, and 9-octadecene-7,12-diol, can also be used.

Among these, from the viewpoints of chargeability and toner strength, it is preferable to use an ethylene oxide adduct of bisphenol A, and/or a propylene oxide adduct of bisphenol A, as the polyhydric alcohol component.

These polyhydric alcohol components may be used singly, or in combination of two or more kinds thereof.

Examples of a divalent carboxylic acid component that is condensed with the polyhydric alcohol component, include aromatic carboxylic acids such as terephthalic acid, isophthalic acid, phthalic acid, naphthalenedicarboxylic acid; aliphatic carboxylic acids such as maleic acid, fumaric acid, succinic acid, alkenylsuccinic acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid; alicyclic carboxylic acids such as cyclohexanedicarboxylic acid; and lower alkyl esters, anhydrides and chlorides of these acids. These can be used singly or in combination of two or more kinds thereof.

Among these polyvalent carboxylic acids, particularly when an alkenylsuccinic acid, or an anhydride, chloride, or a lower alkyl ester having 1 to 3 carbon atoms of the acid is used, due to the presence of an alkenyl group having higher hydrophobicity compared to other functional groups, the amorphous polyester resin can be compatibilized more easily with a crystalline polyester resin. Examples of the alkenylsuccinic acid component include n-dodecenylsuccinic acid, isododecenylsuccinic acid, n-octenylsuccinic acid, and anhydrides, chlorides, and lower alkyl esters having 1 to 3 carbon atoms, of these acids.

Furthermore, when the amorphous polyester resin contains a trivalent or higher-valent carboxylic acid, the polymer chain can adopt a crosslinked structure, and by adopting the crosslinked structure, decrease in the elastic modulus at higher temperatures can be suppressed, while the offset properties at higher temperatures can be enhanced.

Examples of the trivalent or higher-valent carboxylic acid include trimellitic acid, 1,2,4-naphthalenetricarboxylic acid, hemimellitic acid, trimesic acid, mellophanic acid, prehnitic acid, pyromellitic acid, mellitic acid, 1, 2, 3, 4-butanetetracarboxylic acid, and anhydrides, chlorides, and lower alkyl esters having 1 to 3 carbon atoms, of these acids. However, trimellitic acid or anhydride thereof is particularly suitable. These acids may be used singly, or two or more kinds thereof may be used in combination.

The softening temperature of the amorphous polyester resin is preferably 70° C. to 140° C., and more preferably 70° C. to 125° C. Furthermore, the acid value of the amorphous polyester resin is preferably 5 mg KOH/g to 70 mg KOH/g.

(Styrene-Acrylic-Modified Polyester Resin)

According to the present invention, it is preferable that the amorphous polyester resin as a binder resin contains in at least a portion, a styrene-acrylic-modified polyester resin (a hybrid amorphous polyester resin modified by a styrene-acrylic resin). The content proportion of the styrene-acrylic-modified polyester resin in the amorphous polyester resin is preferably 70% to 100% by mass, and more preferably 90% to 100% by mass, relative to 100% by mass of the amorphous polyester resin. The styrene-acrylic-modified polyester resin will be explained below.

According to the present invention, the styrene-acrylic-modified polyester resin refers to a resin in which a polyester segment constructed from a polyester resin, and a styrene-acrylic polymer segment constructed from a styrene-acrylic polymer are linked via a bireactive monomer. The styrene-acrylic polymer segment refers to a polymer part obtainable by polymerizing an aromatic vinyl monomer and a (meth)acrylic acid ester-based monomer.

The styrene-acrylic-modified polyester resin is not particularly limited; however, the resin is preferably a styrene-acrylic-modified polyester resin having the following configuration. Meanwhile, in the case of producing a toner having a core-shell structure, the styrene-acrylic-modified polyester resin used for the binder resin of the core particles and the styrene-acrylic-modified polyester resin used for the shell layer may be identical or different.

The content proportion of the styrene-acrylic polymer segment in the styrene-acrylic-modified polyester resin used for the present invention (hereinafter, also referred to as “styrene-acrylic modification ratio”) is not particularly limited; however, the content proportion is preferably from 5% by mass to 30% by mass, more preferably from 5% by mass to 25% by mass, and even more preferably from 15% by mass to 25% by mass.

The content proportion of the styrene-acrylic polymer segment in the styrene-acrylic-modified polyester resin, that is, the styrene-acrylic modification ratio, refers specifically to the proportion of the mass of an aromatic vinyl monomer and a (meth)acrylic acid ester-based monomer, relative to the total mass of the resin material used for synthesizing the styrene-acrylic-modified polyester resin, that is, the total mass of summing the polymerizable monomer that constitutes a non-modified polyester resin that constitutes the polyester segment, the vinyl monomer and the (meth)acrylic acid ester-based monomer that constitute the styrene-acrylic polymer segment, and the bireactive monomer for linking these segments.

When the styrene-acrylic modification ratio is 5% by mass or more, a toner having a sufficiently high storage modulus is obtained, and therefore, the thin paper separability can be further enhanced. Furthermore, when the styrene-acrylic modification ratio is 30% by mass or less, high sharp melting properties are obtained, and therefore, low temperature fixability can be enhanced. Particularly, in a case where the styrene-acrylic-modified polyester resin is used in the shell layer of a toner having a core-shell structure, the affinity with the core particles is appropriately controlled, and thus a thin and smooth shell layer having a more uniform film thickness can be formed.

In regard to the styrene-acrylic-modified polyester resin used for the present invention, from the viewpoint of reliably obtaining fixability such as low temperature fixability and fixation separability, and heat resistance such as heat-resistant preservability and blocking resistance, the glass transition point is preferably 50° C. to 70° C., and more preferably 50° C. to 65° C., and the softening point is 80° C. to 110° C. The glass transition point in the case of using the styrene-acrylic-modified polyester resin as a binder resin for the core particles, is preferably 40° C. to 60° C., and the softening point is preferably 80° C. to 110° C.

The glass transition point of the styrene-acrylic-modified polyester resin is a value measured according to the method defined in ASTM (standards of the American Society for Testing and Materials) D3418-82 (DSC method).

Specifically, 4.5 mg of a sample was precisely weighed up to two decimal places, and the sample was sealed in an aluminum pan. The sample was mounted on a sample holder of a differential scanning calorimeter “DSC8500” (manufactured by PerkinElmer, Inc). For the reference, an empty aluminum pan was used, and a Heat-Cool-Heat temperature control was performed at a measurement temperature of −0° C. to 120° C., a rate of temperature increase of 10° C./min, and a rate of temperature decrease of 10° C./min. An analysis was conducted based on the data obtained from the 2nd Heat cycle. The value of the intersection of an extension line of the base line before the rise of the first endothermic peak, and the tangent line showing the maximum gradient in the region between the rising portion of the first endothermic peak and the peak apex, is designated as the glass transition temperature.

Furthermore, the softening point of the styrene-acrylic-modified polyester resin is measured as follows.

First, in an environment at 20° C.±1° C. and 50%±5% RH, 1.1 g of a resin is placed on a Petri dish and is spread flat, and the resin is left to stand for 12 hours or longer. Subsequently, the sample is pressed for 30 seconds with a force of 3820 kg/cm² using a molding machine “SSP-10A” (manufactured by Shimadzu Corp.), and thus a cylindrical molded sample having a diameter of 1 cm is produced. Subsequently, this molded sample is extruded through an orifice (1 mm in diameter×1 mm) of a cylindrical die immediately after completion of preheating using a piston having a diameter of 1 cm, in an environment at 24° C.±5° C. and 50%±20% RH, using a flow tester “CFT-500D” (manufactured by Shimadzu Corp.) under the conditions of a load of 196 N (20 kgf), an initiation temperature of 60° C., a preheating time of 300 seconds, and a rate of temperature increase of 6° C./min. The offset method temperature, T_{offset}, measured at an offset value of 5 mm by the melting temperature measuring method of a temperature increase method, is considered as the softening point of the resin.

(Method for Producing Styrene-Acrylic-Modified Polyester Resin)

Regarding the method for producing a styrene-acrylic-modified polyester resin such as described above, an existing general scheme can be used. Representative methods include the following four methods.

(A) A method of polymerizing a polyester segment in advance, reacting the polyester segment with a bireactive monomer, further reacting the product with an aromatic vinyl monomer and a (meth)acrylic acid ester-based monomer for forming a styrene-acrylic polymer segment, and thereby forming a styrene-acrylic polymer segment. That is, a method of polymerizing an aromatic vinyl monomer and a (meth)acrylic acid ester-based monomer for forming a styrene-acrylic polymer segment, in the presence of a bireactive monomer having a group which is capable of reacting with the polyvalent carboxylic acid monomer or the polyhydric alcohol monomer for forming a polyester segment, and a polymerizable unsaturated group, and an unmodified polyester resin.

(B) A method of polymerizing a styrene-acrylic polymer segment in advance, reacting the styrene-acrylic polymer segment with a bireactive monomer, and reacting the product with the polyvalent carboxylic acid monomer and the polyhydric alcohol monomer for forming a polyester segment, and thereby forming a polyester segment.

(C) A method of respectively polymerizing a polyester segment and a styrene-acrylic polymer segment in advance, reacting these with a bireactive monomer, and thereby linking the two segments.

(D) A method of polymerizing a polyester segment in advance, addition polymerizing a styrene-acrylic polymerizable monomer to a polymerizable unsaturated group of the polyester segment, or reacting the polymerizable unsaturated group of the polyester segment with a vinyl group in a styrene-acrylic polymer segment, and linking the two segments.

According to the present invention, the bireactive monomer is a monomer having a group which is capable of reacting with the polyvalent carboxylic acid monomer and/or the polyhydric alcohol monomer for forming a polyester segment of the styrene-acrylic-modified polyester resin, and a polymerizable unsaturated group.

To explain the method (A) more specifically,

when the following steps are carried out:

(1) a mixing step of mixing an unmodified polyester resin for forming a polyester segment, with an aromatic vinyl monomer, a (meth)acrylic acid ester-based monomer, and a bireactive monomer;

(2) a polymerization step of polymerizing the aromatic vinyl monomer and the (meth)acrylic acid ester-based monomer in the presence of the bireactive monomer and the unmodified polyester resin,

a styrene-acrylic polymer segment can be formed at either end of a polyester segment. In this case, a hydroxyl group at an end of a polyester segment and a carboxyl group of the bireactive monomer form an ester bond, and a vinyl group of the bireactive monomer is linked to a vinyl group of the aromatic vinyl monomer or the (meth)acrylic acid-based monomer. Accordingly, the styrene-acrylic polymer segment is linked to the polyester segment. Among the synthesis methods described above, method (A) is most preferred.

According to this method, the styrene-acrylic polymer segment can be added to an end of a chain-like polyester segment, and it is speculated that this styrene-acrylic polymer segment having affinity with the styrene-acrylic resin in the core particles is oriented, so that the polyester segment is exposed to the surface of toner, and thereby a toner having a core-shell structure with a thin uniform shell layer can be formed.

In regard to the mixing step of (1), it is preferable that the system is heated. The heating temperature may be any temperature capable of mixing the unmodified polyester resin, the aromatic vinyl monomer, the (meth)acrylic acid ester-based monomer, and the bireactive monomer. From the viewpoint that satisfactory mixing may be achieved, and the control of polymerization is made easier, the heating temperature can be set to, for example, 80° C. to 120° C., more preferably 85° C. to 115° C., and even more preferably 90° C. to 110° C.

As explained above, the content proportion of the styrene-acrylic polymer segment in the styrene-acrylic-modified polyester resin is the proportion occupied by the sum of the aromatic vinyl monomer and the (meth)acrylic acid ester-based monomer, when the total mass of the resin material used for synthesizing the styrene-acrylic-modified polyester resin is designated as 100% by mass. The content proportion is preferably from 5% by mass to 30% by mass.

Furthermore, the relative proportion of the aromatic vinyl monomer and the (meth)acrylic acid ester-based monomer is preferably considered as a proportion at which the glass transition point (Tg) calculated by the Fox equation represented by the following Expression (i) is in the range of 35° C. to 80° C., and preferably 40° C. to 60° C.

1/Tg=Σ(Wx/Tgx) Expression (i):

wherein in Expression (i), Wx represents the weight fraction of monomer x; and Tgx represents the glass transition point of a homopolymer of monomer x.

Meanwhile, according to the present specification, the bireactive monomer is not to be used for the calculation of the glass transition point.

Among the unmodified polyester resin, the aromatic vinyl monomer, the (meth)acrylic acid ester-based monomer, and the bireactive monomer, the proportion of use of the bireactive monomer is such that when the total mass of the resin material used, that is, the total mass of the four components described above, is designated as 100% by mass, the proportion of the bireactive monomer is preferably from 0.1% by mass to 5.0% by mass, and particularly preferably from 0.5% by mass to 3.0% by mass.

(Aromatic Vinyl Monomer and (Meth)Acrylic Acid Ester-Based Monomer)

The aromatic vinyl monomer and the (meth)acrylic acid ester-based monomer for forming the styrene-acrylic polymer segment have ethylenically unsaturated bonds, with which radical polymerization can be performed.

Examples of the aromatic vinyl monomer include styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2, 4-dimethylstyrene, 3,4-dichlorostyrene, and derivatives thereof.

These aromatic vinyl monomers can be used singly or in combination of two or more kinds thereof.

Examples of the (meth)acrylic acid ester-based monomer include methyl acrylate, ethyl acrylate, butyl acrylate, 2-ethylhexylacrylate, cyclohexylacrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate, and diethylaminoethyl methacrylate. These (meth)acrylic acid ester-based monomers can be used singly or in combination of two or more kinds thereof.

Regarding the aromatic vinyl monomer and the (meth)acrylic acid ester-based monomer for forming the styrene-acrylic polymer segment, it is preferable to use a large amount of styrene or a derivative thereof, from the viewpoint of obtaining excellent chargeability, image quality characteristics, and the like. Specifically, the amount of use of styrene or a derivative thereof is preferably 50% by mass or more of all the monomers used to form the styrene-acrylic polymer segment (aromatic vinyl monomer and (meth)acrylic acid ester-based monomer).

(Bireactive Monomer)

Regarding the bireactive monomer for forming the styrene-acrylic polymer segment, a monomer having a group which can react with the polyvalent carboxylic acid monomer and/or polyhydric alcohol monomer for forming the polyester segment, and a polymerizable unsaturated group, may be favorably used. Specifically, for example, acrylic acid, methacrylic acid, fumaric acid, maleic acid, and maleic anhydride can be used. According to the present invention, it is preferable to use acrylic acid or methacrylic acid as the bireactive monomer.

The polyester resin used to produce the styrene-acrylic-modified polyester resin, is as described above.

(Polymerization Initiator)

In regard to the polymerization step of polymerizing the aromatic vinyl monomer and the (meth)acrylic acid ester-based monomer, it is preferable to perform polymerization in the presence of a radical polymerization initiator. Although the timing for addition of the radical polymerization initiator is not particularly limited; however, from the viewpoint that the control of radical polymerization is facilitated, it is preferable to add the radical polymerization initiator after the mixing step.

Regarding the polymerization initiator, various known polymerization initiators are suitably used. Specific examples include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropylperoxycarbonate, tetralin hydroperoxide, 1-phenyl-2-methylpropyl-1-hydroperoxide, tert-butyl triphenyl peracetate hydroperoxide, tert-butyl performate, tert-butyl peracetate, tert-butyl perbenzoate, tert-butyl phenyl peracetate, tert-butylmethoxyperacetate, and tert-butyl N-(3-toluyl) perpalmitate; and azo compounds such as 2,2′-azobis(2-aminodipropane) hydrochloride, 2,2′-azobis(2-aminodipropane) nitrate, 1,1′-azobis(sodium 1-methylbutyronitrile-3-sulfonate), 4,4′-azobis-4-cyanovaleric acid, and poly(tetraethylene glycol-2,2′-azobisisobutyrate).

(Chain Transfer Agent)

In regard to the polymerization step of polymerizing the aromatic vinyl monomer and the (meth)acrylic acid ester-based monomer, a chain transfer agent that is generally used can be used for the purpose of adjusting the molecular weight of the styrene-acrylic polymer segment. There are no particular limitations on the chain transfer agent, and examples thereof include an alkylmercaptan and a mercapto fatty acid ester.

The chain transfer agent is preferably mixed together with the resin-forming materials during the mixing step.

The amount of addition of the chain transfer agent may vary depending on the desired molecular weight or molecular weight distribution of the styrene-acrylic polymer segment; however, specifically, it is preferable to add the chain transfer agent in an amount in the range of 0.1% to 5% by mass relative to the total amount of the aromatic vinyl monomer, the (meth)acrylic acid ester-based monomer, and the bireactive monomer.

The polymerization temperature for the polymerization step of polymerizing the aromatic vinyl monomer and the (meth)acrylic acid ester-based monomer is not particularly limited, and can be appropriately selected to the extent that the polymerization between the aromatic vinyl monomer and the (meth)acrylic acid ester-based monomer, and bonding thereof to the polyester resin can proceed. The polymerization temperature is, for example, preferably from 85° C. to 125° C., more preferably from 90° C. to 120° C., and even more preferably from 95° C. to 115° C.

In regard to the production of the styrene-acrylic-modified polyester resin, it is practically preferable that the amount of volatile organic materials coming from an emulsification product, such as the amount of residual monomers after the polymerization step, is suppressed to a level of 1,000 ppm or less, more preferably 500 ppm or less, and even more preferably 200 ppm or less.

(Styrene-Acrylic Resin)

In regard to the toner of the present embodiment, it is preferable that the binder resin includes a styrene-acrylic resin, in consideration of the environmental stability of charging. Particularly, when a styrene-acrylic resin is used, together with a crystalline polyester resin, for the core particles of a toner having a core-shell structure, and a styrene-acrylic-modified polyester resin is used for the shell layer, affinity of the core particles and the shell layer is appropriately controlled, and a thin and smooth shell layer having a uniform film thickness can be formed.

It is preferable that the content of the styrene-acrylic resin is adjusted to an amount of usually 40% to 95% by mass, and preferably 60% to 95% by mass, relative to the total amount of the binder resin. When the content is in such a range, the toner thus obtainable has excellent plasticity at the time of thermal fixation, and low temperature fixability can also be obtained.

The polymerizable monomers that are used for the styrene-acrylic resin is an aromatic vinyl monomer and a (meth)acrylic acid ester-based monomer, and it is preferable that the polymerizable monomers have an ethylenically unsaturated bond, with which radical polymerization can be performed. Examples include styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, 3,4-dichlorostyrene, and derivatives thereof. These aromatic vinyl monomers can be used singly or in combination of two or more kinds thereof.

Examples of the (meth)acrylic acid ester-based monomer include methyl acrylate, ethyl acrylate, butyl acrylate, 2-ethylhexylacrylate, cyclohexylacrylate, phenyl acrylate, methyl methacrylate, ethyl methacrylate, butyl methacrylate, hexyl methacrylate, 2-ethylhexyl methacrylate, ethyl β-hydroxyacrylate, propyl γ-aminoacrylate, stearyl methacrylate, dimethylaminoethyl methacrylate, and diethylaminoethyl methacrylate. These (meth)acrylic acid ester-based monomers can be used singly or in combination of two or more kinds thereof. Among the monomers described above, it is preferable to use a styrene-based monomer, and an acrylic acid ester-based monomer and/or a methacrylic acid ester-based monomer in combination.

Regarding the polymerizable monomer, a third vinyl-based monomer can also be used. Examples of the third vinyl-based monomer include acid monomers such as acrylic acid, methacrylic acid, maleic anhydride, and vinyl acetate; acrylamide, methacrylamide, acrylonitrile, ethylene, propylene, butylene, vinyl chloride, N-vinylpyrrolidone, and butadiene.

Regarding the polymerizable monomer, a polyfunctional vinyl monomer may also be used. Examples of the polyfunctional vinyl monomer include diacrylates of ethylene glycol, propylene glycol, butylene glycol, and hexylene glycol; divinylbenzene; and dimethacrylates and trimethacrylates of tertiary or higher alcohols such as pentaerythritol and trimethylolpropane. The copolymerization ratio of the polyfunctional vinyl-based monomer relative to the total amount of the polymerizable monomers is usually 0.001% to 5% by mass, preferably 0.003% to 2% by mass, and more preferably 0.01% to 1% by mass. As a result of the use of a polyfunctional vinyl-based monomer, a gel component that is insoluble in tetrahydrofuran is produced; however, the proportion of the gel component in the entire amount of the polymerization product is usually 40% by mass or less, and preferably 20% by mass or less.

(Method for Producing Styrene-Acrylic Resin)

It is preferable that the styrene-acrylic resin is prepared by using an emulsion polymerization method. Emulsion polymerization can be achieved by dispersing polymerizable monomers such as styrene and an acrylic acid ester in an aqueous medium, and polymerizing the polymerizable monomers. In order to disperse the polymerizable monomers in an aqueous medium, it is preferable to use a surfactant, and for the polymerization, a polymerization initiator and a chain transfer agent can be used.

(Polymerization Initiator)

The polymerization initiator that is used for the polymerization of the styrene-acrylic resin is not particularly limited, and any known polymerization initiator can be used. The polymerization initiators used for the polymerization of the styrene-acrylic polymer segment of the styrene-acrylic-modified polyester resin can be used. Regarding the polymerization initiator used for polymerization, a water-soluble polymerization initiator is suitably used. Specific examples include peroxides such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethylbenzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, tert-butyl triphenyl peracetate hydroperoxide, tert-butyl performate, tert-butyl peracetate, tert-butyl perbenzoate, tert-butyl phenyl peracetate, tert-butyl methoxy peracetate, and tert-butyl N-(3-toluyl) perpalmitate; and azo compounds such as 2,2′-azobis(2-aminodipropane) hydrochloride, 2,2′-azobis(2-aminodipropane) nitrate, 1,1′-azobis(sodium 1-methylbutyronitrile-3-sulfonate), 4,4′-azobis-4-cyanovaleric acid, and poly(tetraethylene glycol-2,2′-azobisisobutyrate).

(Chain Transfer Agent)

In regard to the production of the styrene-acrylic resin, a chain transfer agent may be added together with the polymerizable monomers described above. By adding a chain transfer agent, the molecular weight of the polymer can be controlled. Regarding the chain transfer agent, any known agent can be used, and for example, the chain transfer agents used for the polymerization of the styrene-acrylic polymer segment of the styrene-acrylic-modified polyester resin described above can be used. Examples include an alkylmercaptan and a mercapto fatty acid ester. The amount of addition of the chain transfer agent may vary depending on the desired molecular weight or molecular weight distribution; however, specifically, it is preferable to add the chain transfer agent in an amount in the range of 0.1% to 5% by mass with respect to the polymerizable monomers.

(Surfactant)

In a case where the styrene-acrylic resin is dispersed in an aqueous medium and is polymerized by an emulsion polymerization method, a dispersion stabilizer is usually added in order to prevent aggregation of the dispersed liquid droplets. Regarding the dispersion stabilizer, any known surfactant can be used, and a dispersion stabilizer selected from among a cationic surfactant, an anionic surfactant, a nonionic surfactant and the like can be used. These surfactants can be used in combination of two or more kinds. Meanwhile, the dispersion stabilizer can also be used in a dispersion of a colorant, an offset inhibitor, or the like.

Specific examples of the cationic surfactant include dodecylammonium bromide, dodecyltrimethylammonium bromide, dodecylpyridinium chloride, dodecylpyridinium bromide, and hexadecyltrimethylammonium bromide.

Specific examples of the nonionic surfactant include dodecyl polyoxyethylene ether, hexadecyl polyoxyethylene ether, nonyl phenyl polyoxyethylene ether, lauryl polyoxyethylene ether, sorbitan monooleate polyoxyethylene ether, styryl phenyl polyoxyethylene ether, and monodecanoyl sucrose.

Specific examples of the anionic surfactant include aliphatic soaps such as sodium stearate and sodium laurate; sodium dodecyl sulfate, sodium dodecyl benzenesulfonate, and sodium polyoxyethylene(2) dodecyl ether sulfate.

(Form of Binder Resin)

The binder resin included in the toner of the present invention may be in any form (form of the resin particles).

For example, resin fine particles constructed from the binder resin (binder resin fine particles) may have a so-called single layer structure, or may have a core-shell structure (a form in which a resin that forms the shell portion is aggregated and fused on the surface of core particles). Resin fine particles having a core-shell structure has a resin region (shell portion) having a relatively high glass transition temperature, on the surface of resin fine particles (core particles) that contain a colorant, a mold release agent and the like and have a relatively low glass transition temperature.

Meanwhile, the core-shell structure is not limited to a structure in which the shell portion completely covers the core particles, and for example, a structure in which the shell portion does not completely cover the core particles, and the core particles are exposed in some parts, is also included.

The cross-sectional structure of the core-shell structure can be checked, for example, using a known means such as transmission electron microscopy (TEM) or scanning probe microscopy (SPM).

In a case where resin fine particles having a core-shell structure are used, from the viewpoint of suppressing the deterioration of chargeability attributable to the crystalline polyester resin unit, and further enhancing charge uniformity, a form in which at least a crystalline polyester resin is included in the core particles is preferred. At this time, an amorphous resin may be included in any part of the core particles and the shell portion; however, a form in which the core particles contain a crystalline polyester resin and an amorphous resin, and the shell portion contains an amorphous resin, is particularly preferred. When such a form is employed, the affinity between the crystalline polyester resin and the amorphous resin in the core particles is increased, and it becomes difficult for the crystalline polyester resin to be exposed more at the surface. Therefore, charge uniformity as well as mechanical strength can be further enhanced.

The content of the core portion is preferably 30% to 95% by mass when the total amount of resins in the core portion and the shell portion is designated as 100% by mass.

(Colorant)

Regarding the colorant used for the toner, carbon black, a magnetic substance, a dye, a pigment, and the like can be arbitrarily used, and regarding the carbon black, channel black, furnace black, acetylene black, thermal black, lamp black, or the like is used. Regarding the magnetic substance, ferromagnetic metals such as iron, nickel or cobalt; alloys containing these metals; compounds of ferromagnetic metals such as ferrites and magnetites; and the like can be used.

Examples of the dye that can be used include C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93, and C.I. Solvent Blue 95. Mixtures of these can also be used. Examples of the pigment that can be used include C.I. Pigment Red 5, C.I. Pigment Red 48:1, C.I. Pigment Red 48:3, C.I. Pigment Red 53:1, C.I. Pigment Red 57:1, C.I. Pigment Red 81:4, C.I. Pigment Red 122, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, C.I. Pigment Orange 31, C.I. Pigment Orange 43, C.I. Pigment Yellow 14, C.I. Pigment Yellow 17, C.I. Pigment Yellow 74, C.I. Pigment Yellow 93, C.I. Pigment Yellow 94, C.I. Pigment Yellow 138, C.I. Pigment Yellow 155, C.I. Pigment Yellow 180, C.I. Pigment Yellow 185, C.I. Pigment Green 7, C.I. Pigment Blue 15:3, C.I. Pigment Blue 15:4, and C.I. Pigment Blue 60. Mixtures of these can also be used. A number averaged primary particle diameter may vary depending on the kind; however, the number averaged primary particle diameter is generally preferably about 10 nm to 200 nm.

The content proportion of the colorant is not particularly limited; however, the content proportion is preferably 1% to 30% by mass, and more preferably 2% to 20% by mass, with respect to the binder resin.

(Mold Release Agent (Wax))

Examples of the mold release agent include hydrocarbon-based waxes such as a low molecular weight polyethylene wax, a low molecular weight polypropylene wax, a Fischer-Tropsch wax, a microcrystalline wax, and paraffin wax; and ester waxes such as carnauba wax, pentaerythritol behenic acid ester, behenyl behenate, and behenyl citrate. These can be used singly or in combination of two or more kinds thereof.

The content proportion of the mold release agent is not particularly limited; however, the content proportion is, for example, 2% to 20% by mass, preferably 3% to 18% by mass, and more preferably 4% to 15% by mass, with respect to the binder resin.

Furthermore, regarding the melting point of the mold release agent, from the viewpoints of the low temperature fixability of the toner in electronic photographs and mold releasability, the melting point is preferably 50° C. to 95° C.

In the toner of the present embodiment, if necessary, other internal additives such as a charge control agent; and external additives such as inorganic fine particles, organic fine particles, and a lubricating material, may be incorporated.

(Charge Control Agent)

Regarding the charge control agent, various known compounds can be used. Examples of the charge control agent include, for positive charging, nigrosine-based electron-donating dyes, metal salts of naphthenic acid or higher fatty acids, alkoxylated amines, quaternary ammonium salts, alkylamides, metal complexes, pigments, and fluorine treatment activating agents; and for negative charging, electron-accepting organic complexes, chlorinated paraffin, chlorinated polyesters, and sulfonylamine of copper phthalocyanine.

The amount of addition of the charge control agent is preferably 0.1 parts to 10 parts by mass, and more preferably 0.5 parts to 5 parts by mass, relative to 100 parts by mass of the binder resin in the toner particles that are finally obtained.

(External Additives)

From the viewpoints of the charging performance and fluidity of toner, or from the viewpoint of enhancing the cleaning properties, particles such as known inorganic fine particles or organic fine particles, and a lubricating material can be added as external additives to the surface of the toner particles.

Preferred examples of the inorganic fine particles include inorganic fine particles based on silica, titania, alumina, and strontium titanate.

If necessary, it is preferable that these inorganic fine particles are hydrophobization-treated. According to the present invention, among hydrophobization-treated inorganic fine particles, hydrophobic silica is preferred from the viewpoint of having high chargeability. Such hydrophobic silica may be produced (internally produced), or commercially available products such as hydrophobic fumed silica or hydrophobic sol-gel silica may be purchased.

A number averaged primary particle diameter of the inorganic fine particles (including hydrophobization-treated particles) is preferably 10 nm to 700 nm, more preferably 10 nm to 500 nm, and even more preferably 70 nm to 200 nm. When the number averaged primary particle diameter is in such a range, it is preferable from the viewpoint that stabilized images are obtained through durability. Furthermore, the shape of the inorganic fine particles (including hydrophobization-treated particles) is not particularly limited, and inorganic fine particles having any arbitrary shape such as a spherical shape or an irregular shape can be utilized.

In particular, it is preferable that the external additives include silica particles produced by a sol-gel method (sol-gel silica), and above all, it is preferable to use silica particles having a number averaged primary particle diameter of 70 nm to 200 nm. Such silica particles have an especially high effect of imparting fluidity to the toner, and enables stable printing for a long time period.

Regarding the organic fine particles, spherical organic fine particles having a number averaged primary particle diameter of about 10 nm to 2,000 nm can be used. Specifically, organic fine particles based on a homopolymer of styrene, methyl methacrylate or the like, or based on a copolymer of these, can be used.

The number averaged primary particle diameter of the inorganic fine particles (including hydrophobization-treated particles) or the organic fine particles is measured by an image analysis method. Specifically, a photograph of a toner is taken at a magnification ratio of 30,000 times using a scanning electron microscope, “JSM-7401 (manufactured by JEOL, Ltd.)”, and this photographic image is captured using a scanner. The inorganic fine particles or the organic fine particles on the photographic image are subjected to a binarization treatment using an image processing analyzer, “LUZEX (registered trademark) AP” (manufactured by Nireco Corp.), with a software version Ver. 1.32, and Feret's diameter in the horizontal direction is calculated for any arbitrary 100 particles. The average value is designated as the number averaged primary particle diameter. Here, Feret's diameter in the horizontal direction means the length of a side parallel to the X-axis of a circumscribed rectangle obtainable when an image of an external additive is subjected to binarization. In a case where the inorganic fine particles or the organic fine particles exist as aggregates on the toner surface, the number averaged primary particle diameter of the primary particles forming the aggregates is to be measured. Meanwhile, the number averaged primary particle diameter of various particles disclosed below can be determined as described above.

The lubricating material is used for the purpose of further enhancing the cleaning properties or transferability, and examples of the lubricating material include metal salts of the higher fatty acids, including stearic acid salts of zinc, aluminum, copper, magnesium, and calcium; oleic acid salts of zinc, manganese, iron, copper, and magnesium; palmitic acid salts of zinc, copper, magnesium, and calcium; linolic acid salts of zinc and calcium; and ricinolic acid salts of zinc and calcium. Regarding these external additives, various agents may be used in combination.

The amount of addition of the external additives is preferably 0.1% to 10.0% by mass relative to the total amount of the toner particles.

Regarding the method of adding external additives, a method of adding the external additives using various mixing apparatuses such as a tubular mixer, a Henschel mixer, a Nauta mixer, and a V-type mixer, may be employed.

(Method for Producing Toner)

The method for producing a toner is not particularly limited, and known methods such as a kneading pulverization method, a suspension polymerization method, an emulsion aggregation method, a dissolution suspension method, a polyester extension method, and a dispersion polymerization method, may be used. The toner of the present invention is preferably a toner obtainable by subjecting a resin fine particle dispersion containing a binder resin, and a colorant particle dispersion containing a colorant, to a process of aggregation and fusion in an aqueous medium. Among these, from the viewpoints of uniformity of the particle diameter, controllability of the shape, and ease of the formation of a core-shell structure, it is preferable to employ an emulsion association method (emulsion aggregation method). In the following description, a method for producing a toner according to an emulsion association method (emulsion aggregation method) will be explained.

<Emulsion Association Method (Emulsion Aggregation Method)>

The emulsion association method (emulsion aggregation method) is a method of forming toner particles by mixing a dispersion of fine particles of a (binder) resin (hereinafter, also referred to as “resin fine particles”) dispersed by a surfactant or a dispersion stabilizer, with a dispersion of the toner particle constituent components such as fine particles of a colorant, causing the mixture to aggregate (associate) by adding an aggregating agent until a desired toner particle diameter is obtained, subsequently or simultaneously with aggregation (association) performing fusion between the resin fine particles, and controlling the shape.

Here, the resin fine particles can also be produced into composite particles formed to have plural layers composed of two or more layers that are formed from resins having different compositions.

The resin fine particles can be produced by, for example, an emulsion polymerization method, a mini-emulsion polymerization method, or a phase inversion emulsification method, or can be produced by combining several production methods.

In a case where internal additives are incorporated into the toner particles, the resin fine particles may be produced as fine particles containing the internal additives, or a dispersion of internal additive fine particles formed from internal additives only is prepared separately, and the internal additive fine particles may be aggregated together when the resin fine particles are aggregated. In the case of incorporating the internal additives into the resin fine particles, above all, it is preferable to use a mini-emulsion polymerization method.

Furthermore, according to the emulsion association method (emulsion aggregation method), toner particles having a core-shell structure can also be obtained. Specifically, toner particles having a core-shell structure can be obtained by, first, producing core particles by subjecting binder resin fine particles for core particles and a colorant to aggregation (fusion), subsequently adding binder resin fine particles for shell layer into the dispersion of the core particles, subjecting the binder resin fine particles for shell layer to aggregation and fusion on the surface of the core particles, and thereby forming a shell layer that covers the core particle surfaces.

In the case of producing a toner by the emulsion association method (emulsion aggregation method), the method for producing a toner according to a preferred embodiment includes: (a) a step of preparing a resin fine particle dispersion and a colorant dispersion (hereinafter, also referred to as (preparation step); and (b) a step of mixing the resin fine particle dispersion and the colorant dispersion, and subjecting the mixture to aggregation and fusion (hereinafter, also referred to as aggregation and fusion step).

Each of the steps will be described in detail below.

(a) Preparation Step

Step (a) preferably includes a resin fine particle dispersion preparation process (crystalline polyester resin fine particle dispersion preparation process and amorphous resin fine particle dispersion preparation process), and a colorant dispersion preparation process. Meanwhile, in regard to the resin fine particle dispersion preparation process, a mold release agent may be incorporated into the resin fine particles, or a mold release agent fine particle dispersion containing a mold release agent may be prepared separately, and this dispersion may be added to the aggregation and fusion step.

(a1) Crystalline Polyester Resin Fine Particle Dispersion Preparation Process

The crystalline polyester resin fine particle dispersion preparation process is a process of synthesizing a crystalline polyester resin that constitutes toner particles, dispersing this crystalline polyester resin in the form of fine particles in an aqueous medium, and thereby preparing a dispersion of crystalline polyester resin fine particles.

Regarding the crystalline polyester resin fine particle dispersion, for example, a method of performing a dispersion treatment in an aqueous medium without using a solvent, or a method of dissolving a crystalline polyester resin in a solvent such as ethyl acetate to obtain a solution, emulsifying and dispersing the relevant solution in an aqueous medium using a dispersing machine, and then performing a solvent removal treatment, may be employed.

Regarding the method of dispersing the crystalline polyester resin in an aqueous medium, a method of dissolving or dispersing the relevant crystalline polyester resin in an organic solvent (solvent) to prepare an oil-phase liquid, dispersing the oil-phase liquid in an aqueous medium by phase inversion emulsification or the like, thereby forming oil droplets in a state of being controlled to have a desired particle diameter, and then removing the organic solvent, may be employed.

The aqueous medium refers to a medium containing at least 50% by mass or more of water, and examples of components other than water include organic solvents that dissolve in water. Examples of the organic solvents include methanol, ethanol, isopropanol, butanol, acetone, methyl ethyl ketone, dimethylformamide, methyl cellosolve, and tetrahydrofuran. Among these, it is preferable to use an alcohol-based organic solvent such as methanol, ethanol, isopropanol, or butanol, which is an organic solvent that does not dissolve the resin. Preferably, only water is used as the aqueous medium.

Regarding the organic solvent (solvent) used for the preparation of an oil-phase liquid, from the viewpoint that the removal treatment can be easily carried out after the formation of oil droplets, an organic solvent having a low boiling point and low solubility in water is preferred, and specific examples thereof include methyl acetate, ethyl acetate, methyl ethyl ketone, isopropyl alcohol, methyl isobutyl ketone, toluene, and xylene. These can be used singly or in combination of two or more kinds thereof.

The amount of use of the organic solvent (solvent) (in the case of using two or more kinds, the total amount of use) is preferably 1 part to 300 parts by mass, more preferably 10 parts to 200 parts by mass, and even more preferably 25 parts to 100 parts by mass, relative to 100 parts by mass of the resins. When the amount of use is in such a range, it is preferable from the viewpoint that a dispersion of resin fine particles having a uniform particle size distribution can be obtained.

Furthermore, in the oil-phase liquid, ammonia, sodium hydroxide or the like may also be added in order to cause ion dissociation of carboxyl groups, thereby stably emulsifying the oil-phase liquid in an aqueous phase, and thereby allowing emulsification to proceed smoothly.

The amount of use of the aqueous medium is preferably 50 parts to 2,000 parts by mass, and more preferably 100 parts to 1,000 parts by mass, relative to 100 parts by mass of the oil-phase liquid. When the amount of use of the aqueous medium is adjusted to the range described above, the oil-phase liquid in the aqueous medium can be emulsified and dispersed into a desired particle diameter.

In the aqueous medium, a dispersion stabilizer may be dissolved, and for the purpose of enhancing the dispersion stability of oil droplets, a surfactant, resin fine particles, and the like may be added thereto.

Examples of the dispersion stabilizer include inorganic compounds such as tricalcium phosphate, calcium carbonate, titanium oxide, colloidal silica, and hydroxyappatite. However, since it is necessary to remove the dispersion stabilizer from the toner particles thus obtainable, it is preferable to use a dispersion stabilizer which is soluble in an acid or an alkali, such as tricalcium phosphate, or from the viewpoint of environmental aspects, it is preferable to use a dispersion stabilizer which can be enzymatically decomposed.

Examples of the surfactant include anionic surfactants such as an alkyl benzenesulfonic acid salt, an α-olefin sulfonic acid salt, a phosphoric acid ester, a sodium alkyl diphenyl ether disulfonate, and sodium polyoxyethylene lauryl ether sulfate; amine salt type cationic surfactants such as an alkylamine salt, an aminoalcohol fatty acid derivative, a polyamine fatty acid derivative, and imidazoline, or quaternary ammonium salt type cationic surfactants such as an alkyltrimethylammonium salt, a dialkyldimethylammonium salt, an alkyldimethylbenzyl ammonium salt, a pyridinium salt, an alkylisoquinolinium salt, and benzethonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine, and a N-alkyl-N, N-dimethylammonium betaine. Furthermore, anionic surfactants or cationic surfactants having fluoroalkyl groups can also be used.

Furthermore, examples of the resin fine particles for enhancing dispersion stability include polymethyl methacrylate resin fine particles, polystyrene resin fine particles, and polystyrene-acrylonitrile resin fine particles.

Emulsification dispersion (dispersion treatment described above) of such an oil-phase liquid can be carried out by utilizing mechanical energy, and the dispersing machine for performing emulsification dispersion is not particularly limited. Examples thereof include a low-speed shear type dispersing machine, a high-speed shear type dispersing machine, a friction type dispersing machine, a high-pressure jet type dispersing machine, an ultrasonic dispersing machine such as an ultrasonic homogenizer, and a high-pressure impact type dispersing machine, Ultimizer.

At the time of dispersing, it is preferable to heat the solution. The heating conditions are not particularly limited, but the temperature is usually about 50° C. to 90° C.

The removal of the organic solvent after the formation of oil droplets can be carried out by an operation of slowly heating, in a stirred state, the whole dispersion in a state in which crystalline polyester resin fine particles are dispersed in an aqueous medium, applying strong agitation to the dispersion in a certain temperature range, and then performing solvent removal. Alternatively, the organic solvent can be removed while reducing pressure using an apparatus such as an evaporator.

The particle diameter of the crystalline polyester resin fine particles (oil droplets) in the crystalline polyester resin fine particle dispersion prepared as described above, is preferably adjusted to be 60 nm to 1,000 nm, and more preferably 80 nm to 500 nm, as the volume averaged particle diameter. When the particle diameter is in such a range, it is preferable from the viewpoint of stabilized production of toner. Meanwhile, the volume averaged particle diameter of the relevant resin fine particles (oil droplets) (resin particles) can be measured using a laser diffraction scattering type particle size distribution analyzer (MicroTrac particle size distribution analyzer, “UPA-150” (manufactured by Nikkiso Co., Ltd.), or the like). In addition, the volume averaged particle diameter of these fine particles (oil droplets) can be controlled by the magnitude of the mechanical energy applied at the time of emulsification dispersion.

Furthermore, the content (solid content concentration) of the crystalline polyester resin fine particles in the crystalline polyester resin fine particle dispersion is preferably adjusted to the range of 10% to 50% by mass, and more preferably to the range of 15% to 40% by mass, relative to 100% by mass of the dispersion. When the content is in such a range, expansion of the particle size distribution is suppressed, and the toner characteristics can be enhanced.

(a2) Amorphous Resin Fine Particle Dispersion Preparation Process

The amorphous resin fine particle dispersion preparation process is a process of preparing a dispersion of amorphous resin fine particles by synthesizing an amorphous resin that constitute toner particles, and dispersing this amorphous resin in the form of fine particles in an aqueous medium.

Regarding the method of dispersing an amorphous resin in an aqueous medium, a method (I) of forming amorphous resin fine particles from a monomer for obtaining an amorphous resin, and preparing an aqueous dispersion of the amorphous resin fine particles; and a method (II) of dissolving or dispersing an amorphous resin in an organic solvent (solvent) to prepare an oil-phase liquid, dispersing the oil-phase liquid in an aqueous medium by phase inversion emulsification or the like, thereby forming oil droplets in a state of being controlled to have a desired particle diameter, and then removing the organic solvent (solvent), may be employed.

In method (I), first, a monomer for obtaining an amorphous resin is added to an aqueous medium together with a polymerization initiator, the monomer is polymerized, and thus base particles are obtained. Next, it is preferable to use a technique of adding a radical polymerizable monomer for obtaining an amorphous resin, and a polymerization initiator to the dispersion in which the relevant resin fine particles are dispersed, and seed-polymerizing the radical polymerizable monomer to the base particles.

At this time, a water-soluble polymerization initiator can be used as the polymerization initiator. Regarding the water-soluble polymerization initiator, for example, a water-soluble radical polymerization initiator such as potassium persulfate or ammonium persulfate can be suitably used.

Furthermore, in the seed polymerization reaction system for obtaining amorphous resin fine particles, a chain transfer agent that is generally used can be used for the purpose of regulating the molecular weight of the amorphous resin. Regarding the chain transfer agent, mercaptans such as octylmercaptan, dodecylmercaptan, and t-dodecylmercaptan; mercaptopropionic acids such as n-octyl-3-mercaptopropionate and stearyl-3-mercaptopropionate; a styrene dimer; and the like can be used. These can be used singly or in combination of two or more kinds thereof.

In regard to method (II), the organic solvent (solvent) used for the preparation of the oil-phase liquid is preferably a solvent having a low boiling point and low solubility in water, from the viewpoint that, as described above, the removal treatment after the formation of oil droplets can be easily carried out. Specific examples thereof include methyl acetate, ethyl acetate, methyl ethyl ketone, isopropyl alcohol, methyl isobutyl ketone, toluene, and xylene. These can be used singly or in combination of two or more kinds thereof.

The amount of use of the organic solvent (solvent) (in the case of using two or more kinds, the total amount of use) is usually 10 parts to 500 parts by mass, preferably 100 parts to 450 parts by mass, and more preferably 200 parts to 400 parts by mass, relative to 100 parts by mass of the amorphous resin.

The amount of use of the aqueous medium is preferably 50 parts to 2,000 parts by mass, and more preferably 100 parts to 1,000 parts by mass, relative to 100 parts by mass of the oil-phase liquid. When the amount of use of the aqueous medium is adjusted to the range described above, the oil-phase liquid in the aqueous medium can be emulsified and dispersed into a desired particle diameter.

Furthermore, as described above, the aqueous medium may have a dispersion stabilizer dissolved therein, and a surfactant, resin fine particles and the like may be added to the aqueous medium for the purpose of enhancing the dispersion stability of the oil droplets.

Such emulsification dispersion of the oil-phase liquid can be carried out by utilizing mechanical energy, as described above, and the dispersing machine for performing emulsification dispersion is not particularly limited. Those dispersing machines explained in the section (a1) can be used.

The removal of the organic solvent after the formation of oil droplets can be carried out by an operation of slowly heating, in a stirred state, the whole dispersion in a state in which amorphous resin fine particles are dispersed in an aqueous medium, applying strong agitation to the dispersion in a certain temperature range, and then performing solvent removal. Alternatively, the organic solvent can be removed while reducing pressure using an apparatus such as an evaporator.

The particle diameter of the amorphous resin fine particles (oil droplets) in the amorphous resin fine particle dispersion prepared by Method (I) or (II), is preferably adjusted to 60 nm to 1,000 nm, and more preferably 80 nm to 500 nm, as the volume-based median diameter. Meanwhile, this volume averaged particle diameter is measured by the method described in the Examples. Meanwhile, the volume averaged particle diameter of these oil droplets can be controlled by the magnitude of the mechanical energy applied at the time of emulsification dispersion.

Furthermore, the content of the amorphous resin fine particles in the amorphous resin fine particle dispersion is preferably adjusted to the range of 5% to 50% by mass, and more preferably to the range of 10% to 30% by mass. When the content of the amorphous resin fine particles is in such a range, expansion of the particle size distribution is suppressed, and the toner characteristics can be enhanced.

(a3) Colorant Dispersion Preparation Process

This colorant dispersion preparation process is a process of dispersing a colorant in the form of fine particles in an aqueous medium, and thereby preparing a dispersion of colorant particles.

The relevant aqueous medium is as explained in the section (a1), and in this aqueous medium, the surfactant, resin fine particles and the like as described in the section (a1) can be incorporated for the purpose of enhancing dispersion stability.

Dispersing of the colorant can be carried out by utilizing mechanical energy, and such a dispersing machine is not particularly limited. As described above, a low-speed shear type dispersing machine, a high-speed shear type dispersing machine, a friction type dispersing machine, a high-pressure jet type dispersing machine, an ultrasonic dispersing machine such as an ultrasonic homogenizer, or a high-pressure impact type dispersing machine, Ultimizer, may be employed.

Furthermore, the content of the colorant in the colorant dispersion is preferably adjusted to the range of 10% to 50% by mass, and more preferably to the range of 15% to 40% by mass. When the content is in such a range, an effect of securing color reproducibility is obtained.

(a4) Mold Release Agent Fine Particle Dispersion Preparation Process

This mold release agent fine particle dispersion preparation process is a process of dispersing a mold release agent in the form of fine particles in an aqueous medium, and thereby preparing a dispersion of mold release agent fine particles.

The relevant aqueous medium is as explained in the section (a1), and in this aqueous medium, the surfactant, resin fine particles and the like as disclosed in the section (a1) may be incorporated for the purpose of enhancing dispersion stability.

Dispersing of the mold release agent can be carried out by utilizing mechanical energy, and such a dispersing machine is not particularly limited. As mentioned above, a low-speed shear type dispersing machine, a high-speed shear type dispersing machine, a friction type dispersing machine, a high-pressure jet type dispersing machine, an ultrasonic dispersing machine such as an ultrasonic homogenizer, a high-pressure impact type dispersing machine, namely, Ultimizer, or a high-pressure homogenizer, may be employed. On the occasion of dispersing the mold release agent fine particles, heating may be carried out as necessary.

(b) Aggregation and Fusion Step

This aggregation and fusion step is a step of forming toner particles by adding and mixing a crystalline polyester resin fine particle dispersion, an amorphous resin fine particle dispersion, and a colorant particle dispersion, and optionally other components such as a mold release agent fine particle dispersion; mildly aggregating while taking a balance between the repulsive force of the fine particle surfaces caused by pH adjustment, and the cohesive force caused by the addition of an aggregating agent formed from an electrolyte; inducing association while controlling the average particle diameter and the particle size distribution, and simultaneously inducing fusion between the fine particles by heating and stirring; and thereby controlling the shape. This aggregation and fusion step can also be carried out by utilizing, if necessary, mechanical energy or a heating means.

In the aggregation process, first, the various dispersions thus obtained and a surfactant are mixed to obtain a mixed liquid, heating the mixed liquid to a temperature higher than or equal to the glass transition temperature of the amorphous resin to induce aggregation, and thus aggregate particles are formed. For the formation of aggregate particles, it is preferable to adjust the pH of the mixed liquid, under stirring, to the range of 8 to 12, and it is more preferable to adjust the pH to the range of 9 to 11. When the pH is in such a range, it is preferable from the viewpoint that aggregation with a sharp particle size distribution is enabled. In order to adjust the pH, for example, hydrochloric acid, sulfuric acid, nitric acid, a bicarbonate salt, ammonia, potassium hydroxide, sodium hydroxide, sodium carbonate, potassium carbonate, and the like can be used. At this time, it is also effective to use an aggregating agent.

In regard to this aggregation and fusion step, it is preferable to add a surfactant into the aqueous medium. The various fine particles in the aggregation system can be stably dispersed by adding a surfactant. Furthermore, the distribution of the aspect ratio can be controlled by the amount of addition of the surfactant. Regarding the surfactant, surfactants similar to the surfactants used for the crystalline polyester resin fine particle dispersion preparation process/amorphous resin fine particle dispersion preparation process, and the like can be used; however, an anionic surfactant is preferred, and an alkyl benzenesulfonic acid salt, an α-olefin sulfonic acid salt, a phosphoric acid ester, a sodium alkyl diphenyl ether disulfonate such as sodium dodecyl diphenyl ether disulfonate or sodium nonyl diphenyl ether disulfonate, sodium lauryl sulfate, sodium polyoxyethylene lauryl ether sulfate, and the like are used. A sodium alkyl diphenyl ether disulfonate is preferred, and sodium dodecyl diphenyl ether disulfonate and sodium nonyl diphenyl ether disulfonate are more preferred. By using the surfactants described above, the particle size distribution and the aspect ratio distribution of toner can be easily controlled. That is, according to a preferred embodiment of the present invention, a method for producing an electrostatic charge image developing toner, comprising subjecting at least a binder resin fine particle dispersion containing a binder resin and a colorant particle dispersion containing a colorant, to aggregation and fusion in an aqueous medium in the presence of a sodium alkyl diphenyl ether disulfonate, is provided.

In regard to the aggregation and fusion step, the amount of addition of the surfactant included in the mixed liquid is not particularly limited; however, relative to 100% by mass of the total amount of the binder resin in the resin fine particles (for example, crystalline polyester resin fine particles and amorphous resin fine particles) included in the mixed liquid, the amount of addition of the surfactant is preferably 0.2% to 1.8% by mass (converted to a solid content), and more preferably 0.5% to 1.5% by mass (converted to a solid content). When the amount of addition of the surfactant is 0.2% by mass or more relative to 100% by mass of the binder resin included in the mixed liquid, the difference between the average aspect ratio on the large particle diameter side, AR(H), and the average aspect ratio on the small particle diameter side, AR(L), according to Expression (1) of the toner particles thus obtainable becomes smaller, and thus a toner having a difference in the average aspect ratio represented by Expression (1), AR(L)−AR(H), of 0.250 or less can be easily obtained. Furthermore, when the amount of addition of the surfactant is 1.8% by mass or less relative to 100% by mass of the binder resin included in the mixed liquid, a toner having a difference in the average aspect ratio represented by Expression (1), AR(L)−AR(H), of 0.110 or more can be easily obtained.

Regarding the aggregating agent used, as well as an inorganic metal salt, a complex containing a divalent or higher-valent metal can be suitably used.

Examples of the inorganic metal salt include metal salts such as sodium chloride, potassium chloride, lithium chloride, calcium chloride, barium chloride, magnesium chloride, zinc chloride, aluminum chloride, copper sulfate, magnesium sulfate, aluminum sulfate, manganese sulfate, and calcium nitrate; and inorganic metal salt polymers such as polyaluminum chloride, polyaluminum hydroxide, polysilica iron, and calcium polysulfide. In order to obtain a sharper particle size distribution, the valence of the inorganic metal salt is such that a divalent salt is more suitable than a monovalent salt, a trivalent salt is more suitable than a divalent salt, and a tetravalent salt is more suitable than a trivalent salt.

In regard to the aggregation process, it is preferable to shorten the standing time of leaving the aggregating agent to stand after addition (time taken until heating is initiated) as much as possible. As such, after the aggregating agent is added, it is preferable that heating of the dispersion for aggregation is initiated as rapidly as possible, and heating is conducted to a temperature higher than or equal to the glass transition temperatures of the crystalline polyester resin and the amorphous resin. The reason for this is not clearly understood; however, the aggregated state of the particles changes as a result of the passage of the standing time, and there is a risk of having a problem that the particle size distribution of the toner particles thus obtainable may become unstable, or the surface properties may change. The standing time is usually adjusted to 30 minutes or less, and is preferably 10 minutes or less. The temperature at which the aggregating agent is added is not particularly limited; however, the temperature is preferably a temperature lower than or equal to the glass transition temperatures of the crystalline polyester resin and the amorphous resin, which are binder resins.

At the time of aggregation, it is preferable to heat the system and increase the temperature after the aggregating agent is added. At this time, in a case where the temperature becomes higher than or equal to the fusion temperature due to the heating and temperature increase, the fusion process is simultaneously carried out. Regarding the rate of temperature increase, it is preferable to carry out the temperature increase at a rate in the range of 0.1° C. to 5° C./min. When the rate of temperature increase is in such a range, it is preferable from the viewpoint that aggregation with a sharp particle size distribution is enabled. Furthermore, the heating temperature (peak temperature) is preferably a temperature higher than or equal to the glass transition temperature of the amorphous resin, and it is preferable to carry out the heating at a temperature in the range of 40° C. to 100° C. When the heating temperature is in such a range, it is preferable that aggregation with a sharp particle size distribution is enabled.

Furthermore, after the temperature of the dispersion for aggregation (mixed liquid) reaches the heating temperature, the dispersion is left to stand at that heating temperature preferably for 1 minute to 90 minutes, and more preferably for 10 minutes to 60 minutes. By leaving the dispersion to stand for 1 minute or longer, it is preferable from the viewpoint that aggregation with a sharp particle size distribution is enabled. Furthermore, by setting the standing time to be 90 minutes or less, the distribution of the aspect ratio depending on the particle diameter can be adjusted to a desired range.

Thereafter, it is preferable to continue fusion by maintaining the temperature of the relevant dispersion for aggregation (mixed liquid) for a certain time, preferably until the volume-based median diameter reaches 4.5 μm to 7.0 μm.

Accordingly, aggregation of the particles can be made to proceed effectively (simultaneously, subjected to fusion (loss of interfaces between the particles)), and durability of the toner particles that are finally obtained can be enhanced.

In addition, in a case where a binder resin having a core-shell structure is obtained, an aqueous dispersion of the resin that forms the shell portion (preferably, the amorphous resin described above) is further added to the dispersion having core particles, in a state of maintaining the temperature employed in the aggregation and fusion step, and the resin that forms the shell portion is aggregated and fused at the surface of the particles of binder resin having a single layer structure (core particles) obtained as described above. Accordingly, a binder resin having a core-shell structure is obtained (shell-making process).

When the aggregate particles have acquired a desired particle diameter, by additionally adding amorphous resin fine particles, a toner having a configuration in which the surfaces of the core aggregate particles are coated with an amorphous resin (core-shell particles), can be produced. In the case of additionally adding the amorphous resin fine particles, an aggregating agent may be added or pH adjustment may be carried out, before the additional addition. Meanwhile, in a case where core-shell particles are not formed, when the aggregate particles before performing the relevant operation acquire a desired particle diameter, the following aggregation termination process may be carried out.

When the aggregate particles are measured with, for example, a Coulter counter, and a desired average particle diameter has been acquired, for example, a terminating agent such as sodium chloride is added to the system, and particle growth is terminated (also referred to as an aggregation termination process). Thereafter, if necessary, the liquid containing the aggregate particles is continuously heated and stirred.

The fusion process is a process of forming fused particles, after the aggregation termination process has been carried out, or simultaneously with the above-described aggregation process, by heating the reaction system to a predetermined fusion temperature, thereby causing the various fine particles that constitute aggregate particles to adhere, and fusing the aggregate particles.

The fusion temperature in this fusion process is preferably higher than or equal to the melting point of the crystalline polyester resin, and the fusion temperature is preferably a temperature higher by 0° C. to 20° C. from the melting point of the crystalline polyester resin. Regarding the time for heating, it is acceptable to perform heating to the extent that fusion occurs, and heating may be performed for about 0.5 hours to 10 hours.

After the (aggregation and) fusion, the dispersion of toner particles is cooled, and fused particles are obtained. However, in the case of obtaining a toner by an emulsion association method (emulsion aggregation method), it is preferable that the method further includes a circularity control process (c) that will be described below, after the aggregation and fusion step, and before cooling.

The cooling rate is preferably 0.2° C./min to 20° C./min, and more preferably 2° C./min to 20° C./min. When the cooling rate is in such a range, it is preferable from the viewpoint that the toner surface after cooling becomes smooth. The cooling method is not particularly limited, and examples include a method of cooling by introducing a coolant from the outside of the reaction container, and a method of cooling by introducing cool water directly to the reaction system.

(c) Circularity Control Process

Regarding a circularity control treatment, specifically, a heating treatment of heating the particles obtained in the aggregation and fusion step may be employed. Circularity can be controlled by the heating temperature and the retention time. By increasing the heating time or by lengthening the retention time, the circularity can approach 1.

The heating temperature for the circularity control treatment is preferably 70° C. to 95° C. Regarding the control of circularity, control is enabled by measuring the circularity of particles having a particle diameter of 2 μm or more using a circularity measuring apparatus while heating, and appropriately determining whether a desired circularity has been obtained.

Furthermore, in regard to the method for producing a toner according to an emulsion association method (emulsion aggregation method), the method may include (d) a filtration and washing step, (e) a drying step, and (f) an external additive addition step.

(d) Filtration and Washing Step

In this filtration and washing step, a filtration treatment of cooling the dispersion of toner particles thus obtained, to obtain a cooled slurry, subjecting the toner particles to solid-liquid separation from the this cooled dispersion of toner particles using a solvent such as water, and thereby separating by filtration the toner particles; and a washing treatment of eliminating attached substances such as a surfactant from the separated toner particles (cake-like aggregates), are provided. Specific methods for solid-liquid separation and washing include a centrifugation method; a reduced pressure filtration method of using an aspirator, a Nutsche filter or the like; and a filtration method of using a filter press or the like. These are not particularly limited. In regard to this filtration and washing step, pH adjustment, pulverization and the like may be appropriately carried out. These operations may also be repeated.

(e) Drying Step

In this drying step, the washing-treated toner particles are subjected to a drying treatment. Examples of the drying machine that is used in this drying step include an oven, a spray dryer, a vacuum freeze-dryer, a reduced pressure dryer, a static shelves dryer, a mobile rack dryer, a fluidized bed dryer, a rotary dryer, and a stirring dryer, and these are not particularly limited. Meanwhile, the amount of moisture measured by the Karl-Fischer titration method in the drying-treated toner particles is preferably 5% by mass or less, and more preferably 2% by mass or less.

Furthermore, in a case where the drying-treated toner particles are aggregated by a weak interparticle attractive force and form aggregates, the relevant aggregates may be subjected to a crushing treatment. Here, regarding the crushing treatment apparatus, mechanical crushing apparatuses such as a jet mill, a co mill, a Henschel mixer, a coffee pulverizer, and a food processor can be used.

(f) External Additive Addition Step

This external additive addition step is a step of adding a charge control agent or external additives such as various inorganic fine particles, organic fine particles, or a lubricating agent, to drying-treated toner particles for the purpose of improving fluidity and chargeability, and enhancing the cleaning properties. This step is carried out as necessary. Regarding the apparatus used for adding external additives, various known mixing apparatuses such as a tubular mixer, a Henschel mixer, a Nauta mixer, a V-type mixer, and a sample mill may be employed. Furthermore, in order to adjust the particle size distribution of the toner to an appropriate range, sieve classification may also be performed as necessary.

(Developing Agent)

Regarding the toner such as described above, for example, the case where a magnetic substance is incorporated into the toner, and the toner is used as a single-component magnetic toner; the case where the toner is mixed with a so-called carrier, and the toner is used as a two-component developing agent; and the case where a non-magnetic toner is used alone, can be considered, and the toner can be suitably used in all of these cases.

Regarding the carrier that constitute a two-component developing agent, magnetic particles formed from conventionally known materials, such as metals such as iron, ferrite, and magnetite; alloys of those metals and metals such as aluminum and lead, can be used, and it is particularly preferable to use ferrite particles.

Regarding the carrier, it is preferable to use a carrier that is further coated with a resin, or a so-called resin dispersed type carrier obtained by dispersing magnetic particles in a resin. The resin composition for coating is not particularly limited; however, examples include an olefin resin, a cyclohexyl methacrylate-methyl methacrylate copolymer, a styrene resin, a styrene-acrylic resin, a silicone resin, an ester resin, or a fluororesin is used. Furthermore, the resin for constituting the resin dispersed type carrier is not particularly limited, and known resins can be used. For example, an acrylic resin, a styrene-acrylic resin, a polyester resin, a fluororesin, and a phenolic resin can be used.

Regarding the carrier, the volume averaged particle diameter is preferably 15 μm to 100 μm, and more preferably 25 μm to 80 μm.

(Image Forming Method)

The toner of the present invention can be used in a general electrophotographic mode image forming method. Regarding the image forming apparatus that realizes such an image forming method, for example, an apparatus including a photoreceptor, which is an electrostatic latent image support; a charging means for applying a constant potential to the surface of the relevant photoreceptor through corona discharge of the same polarity as that of the toner; an exposure means for forming an electrostatic latent image by performing imagewise exposure based on the image data, on the surface of the evenly charged photoreceptor; a developing means for forming a toner image by conveying toner to the surface of the photoreceptor and developing the electrostatic latent image; a transfer means for transferring the toner image to a transfer material, with the use of an intermediate transfer body as necessary; and a fixing means for fixing the toner image on the transfer material, can be used. Among those image forming apparatuses having such a configuration, the toner can be suitably used for a color image forming apparatus configured such that an image forming unit related to plural photoreceptors are provided along an intermediate transfer body, and particularly a tandem type color image forming apparatus in which photoreceptors are disposed in series on an intermediate transfer body.

Furthermore, the toner of the present invention can be suitably used for an apparatus in which the fixing temperature (surface temperature of the fixing member) is a relatively low temperature such as 100° C. to 200° C.

Furthermore, the toner of the present invention can be suitably used for high-speed machines in which the linear velocity of the electrostatic latent image support is set to 100 mm/sec to 500 mm/sec.

### EXAMPLES

The effects of the present invention will be explained using the following Examples and Comparative Examples, but the present invention is not intended to be limited to these embodiments. There are occasions in which the indication of “parts” or “percent (%)” is used in the Examples, and unless particularly stated otherwise, these units represent “parts by mass” or “percent (%) by mass”. Also, unless particularly stated otherwise, the various operations are carried out at room temperature (25° C.)

### Example 1

### Preparation of Toner 1

(Preparation of Crystalline Polyester Resin [1])

315 parts by mass of 1,10-decanedicarboxylic acid (dodecanedioic acid) and 252 parts by mass of 1, 9-nonanediol were introduced into a reactor equipped with a stirrer, a thermometer, a cooling tube and a nitrogen gas inlet tube, and the reactor was purged with dry nitrogen gas. Subsequently, 0.1 parts by mass of titanium tetrabutoxide was added thereto, and under a nitrogen gas stream, a polymerization reaction was carried out for 8 hours at 180° C., while the system was stirred. Furthermore, 0.2 parts by mass of titanium tetrabutoxide was added thereto, the temperature was raised to 220° C., and the polymerization reaction was carried out for 6 hours with stirring. Subsequently, the pressure inside the reactor was decreased to 10 mmHg, and the reaction was carried out under reduced pressure. Thus, a crystalline polyester resin [1] was obtained. The weight average molecular weight (Mw) of the crystalline polyester resin [1] measured by gel permeation chromatography (GPC) was 14,000.

Furthermore, regarding the melting point (Tm) of the crystalline polyester resin [1], using differential scanning calorimetry (DSC), the endothermic peak temperature on a DSC curve during the second course of temperature increase was defined as the melting point. The melting point (Tm) of the crystalline polyester resin [1] was 72° C.

(Preparation of Aqueous Dispersion of Crystalline Polyester Resin Fine Particles)

200 parts by mass of the crystalline polyester resin [1] was dissolved in 200 parts by mass of ethyl acetate that was heated to 70° C., and then the solution was mixed with an aqueous solution obtained by dissolving sodium polyoxyethylene lauryl ether sulfate in 800 parts by mass of ion-exchanged water until the concentration became 1% by mass. The mixture was dispersed using an ultrasonic homogenizer. Ethyl acetate was removed from this solution under reduced pressure, and then the solid content concentration was adjusted to 20% by mass. Furthermore, the pH was adjusted to 8.5 using ammonia. Accordingly, an aqueous dispersion of a crystalline polyester resin, in which the crystalline polyester resin [1] fine particles are dispersed in an aqueous medium, was prepared. The average particle diameter of the crystalline polyester resin [1] fine particles was 210 nm.

(Preparation of Aqueous Dispersion of Amorphous Resin Fine Particles (X1))

<<First Stage Polymerization>>

Into a 5-L reactor equipped with a stirring device, a temperature sensor, a cooling tube, and a nitrogen inlet device, 8 parts by mass of sodium dodecyl sulfate and 3000 parts by mass of ion-exchanged water were introduced, and while the mixture was stirred at a stirring speed of 230 rpm under a nitrogen gas stream, the internal temperature was raised to 80° C. After the temperature increase, 10 parts by mass of potassium persulfate dissolved in 200 parts by mass of ion-exchanged water was added thereto, and the liquid temperature was adjusted again to 80° C. A monomer mixed liquid composed of:

| | |
|---|---|
| Styrene | 480 parts by mass |
| n-Butyl acrylate | 250 parts by mass |
| Methacrylic acid | 68.0 parts by mass |

was added dropwise to the reactor over one hour, and then polymerization was carried out by heating and stirring the mixture for 2 hours at 80° C. Thus, a dispersion of resin fine particles (x1) was prepared.

<<Second Stage Polymerization>>

Into a 5-L reactor equipped with a stirring device, a temperature sensor, a cooling tube, and a nitrogen inlet device, a solution obtained by dissolving 7 parts by mass of sodium polyoxyethylene(2) dodecyl ether sulfate in 3000 parts by mass of ion-exchanged water was introduced, and the solution was heated to 98° C. Subsequently, 260 parts by mass of the dispersion of resin fine particles (x1), and a solution produced by dissolving monomers and a mold release agent composed of:

| | | |
|---|---|---|
| Styrene (St) | 295 | parts by mass |
| n-Butyl acrylate (BA) | 96 | parts by mass |
| Methacrylic acid (MAA) | 20 | parts by mass |
| n-Octyl-3-mercaptopropionate | 1.5 | parts by mass |
| Mold release agent: Behenyl | 190 | parts by mass |
| behenate (melting point 73° C.) | | |

at 90° C. were added to the reactor. The mixture was mixed and dispersed for 1 hour using a mechanical dispersing machine having a circulating channel, “CLEARMIX” (manufactured by M Technique Co., Ltd.). Thus, a dispersion containing emulsified particles (oil droplets) was prepared.

Next, to this dispersion, an initiator solution produced by dissolving 6 parts by mass of potassium persulfate in 200 parts by mass of ion-exchanged water was added, and polymerization was performed by heating and stirring this system over 1 hour at 84° C. Thus, a dispersion of resin fine particles (x2) was prepared.

<<Third Stage Polymerization>>

Furthermore, 400 parts by mass of ion-exchanged water was added to the dispersion of resin fine particles (x2) prepared as described above, and the mixture was thoroughly mixed. Subsequently, a solution produced by dissolving 11 parts by mass of potassium persulfate in 400 parts by mass of ion-exchanged water was added thereto. A monomer mixed liquid composed of:

| | | |
|---|---|---|
| Styrene (St) | 450 | parts by mass |
| n-Butyl acrylate (BA) | 160 | parts by mass |
| Methacrylic acid (MAA) | 40 | parts by mass |
| n-Octyl-3-mercaptopropionate | 8 | parts by mass |

was added dropwise to the mixture over 1 hour under the temperature conditions of 82° C. After completion of dropwise addition, polymerization was performed by heating and stirring the mixture for 2 hours, and then the resultant was cooled to 28° C. Thus, an aqueous dispersion of amorphous resin fine particles (X1) formed from a vinyl resin was prepared.

For the aqueous dispersion of amorphous resin fine particles (X1) thus obtained, the volume-based median diameter of the amorphous resin fine particles was 220 nm, the glass transition temperature (Tg) measured with a differential scanning calorimeter (DSC) was 55° C., and the weight average molecular weight (Mw) measured by gel permeation chromatography (GPC) was 32,000.

(Preparation of Aqueous Dispersion of Amorphous Resin Fine Particles for Shell (S1))

Raw material monomers for an addition polymerization-based resin (styrene-acrylic resin: StAc) unit, including a bireactive monomer, and a radical polymerization initiator, as described below, were introduced into a dropping funnel.

| | |
|---|---|
| Styrene | 80 parts by mass |
| n-Butyl acrylate | 20 parts by mass |
| Acrylic acid | 10 parts by mass |
| Polymerization initiator (di-t-butyl peroxide) | 16 parts by mass |

Furthermore, raw material monomers of a polycondensation-based resin (amorphous polyester resin) unit as described below were introduced into a four-necked flask equipped with a nitrogen inlet tube, a dehydration tube, a stirrer and a thermocouple, and the raw material monomers were heated to 170° C. to dissolve.

| | |
|---|---|
| 2-mol propylene oxide adduct of bisphenol A | 285.7 parts by mass |
| Terephthalic acid | 66.9 parts by mass |
| Fumaric acid | 47.4 parts by mass |

Next, the raw material monomers of the addition polymerization-based resin were added dropwise, with stirring, for 90 minutes, and the mixture was aged for 60 minutes. Subsequently, unreacted addition polymerization monomers were removed under reduced pressure (8 kPa).

Thereafter, 0.4 parts by mass of Ti(OBu)₄ as an esterification catalyst was introduced into the flask, and the temperature was increased to 235° C. A reaction was carried out for 5 hours at normal pressure (101.3 kPa) and for another one hour under reduced pressure (8 kPa).

Next, the reaction mixture was cooled to 200° C., and then the reaction was performed under reduced pressure (20 kPa) until a desired softening point was reached. Subsequently, solvent removal was performed, and thus a resin for shell (s1) as an amorphous resin was obtained. For the resin for shell (s1) thus obtained, the glass transition temperature (Tg) was 60° C., and the weight average molecular weight (Mw) was 30,000.

100 parts by mass of the resin for shell (s1) thus obtained was dissolved in 400 parts by mass of ethyl acetate (manufactured by Kanto Chemical Co., Inc.), and this was mixed with 638 parts by mass of a sodium lauryl sulfate solution at a concentration of 0.26% by mass that had been produced in advance. The mixture was ultrasonically dispersed, while stirred, for 30 minutes at a V-level of 300 μA using an ultrasonic homogenizer “US-150T” (manufactured by Nippon Seiki Co., Ltd.). Subsequently, ethyl acetate was completely removed in a state of being heated to 40° C., while the mixture was stirred for 3 hours under reduced pressure, using a diaphragm vacuum pump “V-700” (manufactured by Buchi Labortechnik AG). Thus, an aqueous dispersion of amorphous resin fine particles for shell (S1) having a solid content of 13.5% by mass was prepared. At this time, the particles included in the aqueous dispersion of amorphous resin fine particles for shell (S1) thus obtained had a volume-based median diameter of 160 nm.

(Preparation of Aqueous Dispersion of Colorant Particles)

90 parts by mass of sodium dodecyl sulfate was added to 1,600 parts by mass of ion-exchanged water. While this solution was stirred, 420 parts by mass of copper phthalocyanine (C.I. Pigment Blue 15:3) was slowly added thereto, and subsequently, the mixture was subjected to a dispersion treatment using a stirring apparatus “CLEARMIX” (manufactured by M Technique Co., Ltd.). Accordingly, an aqueous dispersion of colorant particles was prepared. The volume-based median diameter of the colorant particles in the aqueous dispersion of colorant particles thus obtained was 110 nm.

(Aggregation and Fusion Step)

Into a reactor equipped with a stirring device, a temperature sensor and a cooling tube, 288 parts by mass (converted to a solid content) of the aqueous dispersion of amorphous resin fine particles (X1), 40 parts by mass (converted to a solid content) of the aqueous dispersion of crystalline polyester resin fine particles, 1% by mass (converted to a solid content) of sodium dodecyl diphenyl ether disulfonate on the basis of resin ratio (relative to 100% by mass of the total amount of binder resins), and 2,000 parts by mass of ion-exchanged water were introduced, and an aqueous solution of sodium hydroxide at 5 mol/liter was added thereto to adjust the pH to 10.

Thereafter, 30 parts by mass (converted to a solid content) of the aqueous dispersion of colorant particles was introduced into the reactor, and then an aqueous solution produced by dissolving 60 parts by mass of magnesium chloride in 60 parts by mass of ion-exchanged water was added thereto at 30° C. for 10 minutes under stirring. Thereafter, the mixture was left to stand for 3 minutes, and then temperature increase was initiated. This system was heated up to 80° C. over 60 minutes, and after the system reached 80° C., the system was left to stand for 30 minutes. Subsequently, while the stirring speed was adjusted so as to obtain a particle diameter growth rate of 0.01 μm/min, the particle diameter of associated particles was measured using “COULTER MULTISIZER 3” (manufactured by Beckman Coulter, Inc.). The particles were grown until the volume-based particle diameter (median diameter) reached 6.0 μm.

Thereafter, 72 parts by mass (converted to a solid content) of the aqueous dispersion of amorphous resin fine particles for shell (S1) was introduced thereinto for 30 minutes, and at the time point at which the supernatant of the reaction liquid became clear, an aqueous solution produced by dissolving 190 parts by mass of sodium chloride in 760 parts by mass of ion-exchanged water was added thereto to terminate particle growth. Furthermore, the temperature was increased, and fusion of particles was induced by heating and stirring the mixture at 90° C. At the time point at which the average circularity reached 0.970 as measured using an analyzer for the average circularity of toner, “FPIA-3000” (manufactured by Sysmex Corp.) (HPF detection number was 4,000), the system was cooled to 30° C. at a cooling rate of 2.5° C./min.

Subsequently, the system was subjected to solid-liquid separation, and the dehydrated toner cake was washed by repeating the operation of redispersing the toner cake in ion-exchanged water and treating the resultant by solid-liquid separation, three times. Subsequently, the toner cake was dried for 24 hours at 40° C. Accordingly, toner particles were obtained.

Meanwhile, the average circularity described above is a value calculated by taking images using “FPIA-3000” (manufactured by Sysmex Corp.) under the analysis conditions of HPF (high magnification image pick-up) mode, calculating the circularity for individual toner particles according to the following formula, adding the circularities of various toner particles, and dividing the resultant by the total number of toner particles. When the HPF detection number is in the range described above, reproducibility is obtained.

Circularity=(Circumferential length of a circle having the same projected area as that of a particle image)/(circumferential length of a particle projected image)

Here, the average circularity according to the present Example was measured for an aqueous dispersion of toner before the washing step; however, it was confirmed that the same value as obtained even if the toner was analyzed after the addition of external additives.

(Addition of External Additives)

100 parts by mass of the toner particles thus obtained was subjected to an external additive treatment of adding 0.6 parts by mass of hydrophobic silica (number averaged primary particle diameter=12 nm, degree of hydrophobicity=68) and 1.0 part by mass of hydrophobic titanium oxide (number averaged primary particle diameter=20 nm, degree of hydrophobicity=63), mixing the mixture using a “HENSCHEL MIXER” (manufactured by Mitsui Miike Machinery Co., Ltd.) at a rotating blade circumferential speed of 35 mm/sec and at 32° C. for 20 minutes, and then removing coarse particles using a sieve having a mesh size of 45 μm. Thus, Toner 1 was obtained.

### Example 2

### Preparation of Toner 2

Toner 2 was obtained in the same manner as in the case of Toner 1, except that in connection with the production of Toner 1, the amount of sodium dodecyl diphenyl ether disulfonate incorporated was changed to 1.5% by mass.

### Example 3

### Preparation of Toner 3

Toner 3 was obtained in the same manner as in the case of Toner 1, except that in connection with the production of Toner 1, the amount of sodium dodecyl diphenyl ether disulfonate incorporated was changed to 0.5% by mass.

### Example 4

### Preparation of Toner 4

Toner 4 was obtained in the same manner as in the case of Toner 1, except that in connection with the production of Toner 1, the standing time after the system reached 80° C. was changed to 15 minutes.

### Example 5

### Preparation of Toner 5

Toner 5 was obtained in the same manner as in the case of Toner 1, except that in connection with the production of Toner 1, the standing time after the system reached 80° C. was changed to 45 minutes.

### Example 6

### Preparation of Toner 6

Toner 6 was obtained in the same manner as in the case of Toner 1, except that in connection with the production of Toner 1, the amount of the aqueous dispersion of amorphous resin fine particles was changed to 328 parts by mass (converted to a solid content), and the amount of the aqueous dispersion of crystalline polyester resin fine particles was changed to 0 parts by mass (converted to a solid content).

### Example 7

### Preparation of Toner 7

Toner 7 was obtained in the same manner as in the case of Toner 1, except that in connection with the production of Toner 1, the growth-terminated particle diameter was set to 5.0 μm as the volume-based median diameter.

### Example 8

### Preparation of Toner 8

Toner 8 was obtained in the same manner as in the case of Toner 1, except that in connection with the production of Toner 1, the growth-terminated particle diameter was set to 7.0 μm as the volume-based median diameter.

### Example 9

### Preparation of Toner 9

Toner 9 was obtained in the same manner as in the case of Toner 1, except that in connection with the production of Toner 1, the standing time after the system reached 80° C. was changed to 60 minutes.

### Example 10

### Preparation of Toner 10

Toner 10 was obtained in the same manner as in the case of Toner 1, except that in connection with the production of Toner 1, 0.6 parts by mass of hydrophobic silica (number averaged primary particle diameter=12 nm), 1.0 part by mass of hydrophobic titanium oxide (number averaged primary particle diameter=20 nm), and 1.0 part by mass of sol-gel silica (number averaged primary particle diameter=110 nm) were used as external additives.

### Comparative Example 1

### Preparation of Toner 11

Toner 11 was obtained in the same manner as in the case of Toner 1, except that in connection with the production of Toner 1, the amount of sodium dodecyl diphenyl ether disulfonate incorporated was changed to 2.0% by mass.

### Comparative Example 2

### Preparation of Toner 12

Toner 12 was obtained in the same manner as in the case of Toner 1, except that in connection with the production of Toner 1, the amount of sodium dodecyl diphenyl ether disulfonate incorporated was changed to 0% by mass.

### Comparative Example 3

### Preparation of Toner 13

Toner 13 was obtained in the same manner as in the case of Toner 1, except that in connection with the production of Toner 1, the standing time after the system reached 80° C. was omitted.

(Production of Developer)

For each of the Toners 1 to 13 thus obtained, a ferrite carrier coated with a silicone resin and having a volume averaged particle diameter of 60 μm was added such that the concentration of each of the Toners 1 to 13 obtained as described above would be 6% by mass, and the toner and the ferrite carrier were mixed. Thus, Developers 1 to 13 were prepared.

### [Melting Point of Crystalline Polyester Resin and Glass Transition Temperature (Tg) of Amorphous Resin]

The melting point (endothermic peak temperature) of the crystalline polyester resin and the glass transition temperature (Tg) of the amorphous resin were obtained according to ASTM D3418 using a differential scanning calorimeter (DSC-60A manufactured by Shimadzu Corp.). Temperature correction of the detection unit of this apparatus (DSC-60A) was achieved using the melting points of indium and zinc, and the calorie correction was achieved using the heat of melting of indium. An aluminum pan was used for samples. As a control, an empty pan was mounted, the temperature was increased at a rate of temperature increase of 10° C./min, the temperature was held at 200° C. for 5 minutes, the temperature was decreased from 200° C. to 0° C. using liquid nitrogen at a rate of −10° C./min, the temperature was held at 0° C. for 5 minutes, and the temperature was increased again from 0° C. to 200° C. at a rate of 10° C./min. An analysis was made from the endothermic curve at the time of second temperature increase. For the amorphous resin, the onset temperature was designated as Tg, and for the crystalline polyester resin, the endothermic peak temperature was obtained from the maximum peak.

### [Average Particle Diameters of Resin Fine Particles, Colorant Particles, and Mold Release Agent]

The average particle diameters of the resin fine particles, colorant particles, mold release agent, and the like were measured using a laser diffraction scattering type particle size distribution analyzer (MicroTrac particle size distribution analyzer “UPA-150” (manufactured by Nikkiso Co., Ltd.)).

### [Volume Averaged Particle Diameter and Coefficient of Variation of Volume Particle Size Distribution of Toner Particles]

For each of the Toners 1 to 13 obtained in Examples and Comparative Examples described above, a volume averaged particle diameter and a coefficient of variation of volume particle size distribution of the toner particles were measured and calculated using an analyzer obtained by connecting a computer system equipped with data processing software “SOFTWARE V3.51” (manufactured by Beckman Coulter, Inc.), to a precise particle size distribution analyzer “MULTISIZER-3” (manufactured by Beckman Coulter, Inc.).

Specifically, 0.02 g of a toner as an analytic sample is added to 20 mL of a surfactant solution (a surfactant solution produced by diluting, for example, a neutral detergent including surfactant components 10 times with pure water, intended for toner dispersion), and the mixture is mixed thoroughly. Subsequently, the mixture is sufficiently dispersed, and thus a toner dispersion is produced. This toner dispersion is injected into a beaker containing “ISOTON (registered trademark) II” (manufactured by Beckman Coulter, Inc.) on a sample stand, using a pipette until the display concentration of the analyzer reaches 8%. Here, when the sample is adjusted to this concentration, measured values with reproducibility can be obtained. Then, for the analyzer, the number of analyzed particle count was set to 25,000, and the aperture diameter was set to 100 μm. Thus, the volume averaged particle diameter and the coefficient of variation of volume particle size distribution were measured.

### [Average Aspect Ratio of Toner Particles]

For each of the Toners 1 to 13 obtained in Examples and Comparative Examples as described above, an average aspect ratio of the toner particles was measured using a flow type particle image analyzer “FPIA-3000” (manufactured by Sysmex Corp.). Specifically, a toner as an analytic sample was thoroughly mixed with an aqueous solution containing a surfactant, and the mixture was sufficiently dispersed. Subsequently, images were taken using “FPIA-3000” (manufactured by Sysmex Corp.) under the analysis conditions of HPF (high magnification image pick-up) mode at an appropriate density of HPF detection number of 3,000 to 10,000, and the aspect ratio was calculated for individual toner particles according to the following formula. The aspect ratios of various toner particles were added, and the resultant was divided by the total number of toner particles. Thus, the average aspect ratio was calculated. When the HPF detection number is in the range described above, reproducibility is obtained.

Aspect ratio=(Length of straight line vertically connecting two straight lines when an image is placed between two straight lines that are parallel at the maximum length)/(maximum length at two points on the contour line of a particle image(maximum length))

### [Equivalent Circle Average Particle Diameter of Toner Particles]

For each of the Toners 1 to 13 obtained in Examples and Comparative Examples, regarding an equivalent circle average particle diameter of the toner particles, a value measured using a flow type particle image analyzer “FPIA-3000” (manufactured by Sysmex Corp.) was used. Specifically, the equivalent circle average particle diameter was calculated by thoroughly mixing a toner as an analytic sample with an aqueous solution containing a surfactant, sufficiently dispersing the mixture, subsequently taking images using “FPIA-3000” (manufactured by Sysmex Corp.) under the analysis conditions of HPF (high magnification image pick-up) mode at an appropriate density of HPF detection number of 3,000 to 10,000, calculating the equivalent circle particle diameter for individual toner particles according to the following formula, adding the equivalent circle particle diameters of various toner particles, and dividing the value by the total number of particles. When the HPF detection number is in the range described above, reproducibility is obtained.

Equivalent circle particle diameter=(Cross-sectional area of particle image/π)^{1/2}×2

### [Evaluation Method]

Granularity [GI Value]

Using a commercially available color multifunction machine “BIZHUB PRO C6500” (manufactured by Konica Minolta Business Technologies, Inc.), printing of forming a band-shaped solid image having a print ratio of 5% was performed on 100,000 sheets of A4-sized high-quality paper (65 g/m²) as test images in a low temperature low humidity environment (temperature 10° C., humidity 15% RH). At the beginning of printing and after printing of 100,000 sheets, grayscale patterns with 32 levels of gradation ratio were printed out, and these grayscale patterns were subjected to Fourier transformation processing, in which the read values obtained by CCD were processed by MTF (Modulation Transfer Function) correction. The GI values (Graininess Index) adjusted to the human relative visibility were measured, and the maximum GI value was determined. The variation value Δ of the GI values at the beginning of printing and after printing of 100,000 sheets was evaluated according to the following evaluation criteria. The results are presented in Table 1.

Evaluation Criteria

⊙: At the beginning of printing and after printing of 100,000 sheets, the variation value Δ of GI value was less than 0.02 (acceptable)

◯: At the beginning of printing and after printing of 100,000 sheets, the variation value Δ of GI value was 0.02 or more but less than 0.04 (acceptable)

Δ: At the beginning of printing and after printing of 100,000 sheets, the variation value Δ of GI value was 0.04 or more but less than 0.06 (acceptable)

x: At the beginning of printing and after printing of 100,000 sheets, the variation value Δ of GI value was 0.06 or more (unacceptable)

The configurations of Examples and Comparative Examples and the evaluation results are presented in the following Table 1. Meanwhile, in the following Table 1, “Cpes” represents crystalline polyester resin.

TABLE 1

| | | Toner | Coefficient of | Equivalent | | | | | | |
|---|---|---|---|---|---|---|---|---|---|---|
| | | configuration | variation of volume | circle average | Average aspect ratio | | | Granularity (GI value) | | |
| | | Cpes content | particle size | particle diameter | | | AR(L) − | Initial | After | |
| | | (% by mass) | distribution (%) | D(μm) | AR(L) | AR(H) | AR(H) | image | printing | Δ |
| Example 1 | Toner 1 | 10 | 16.4 | 6.1 | 0.935 | 0.723 | 0.212 | 0.14 | 0.15 | ⊙ 0.01 |
| Example 2 | Toner 2 | 10 | 16.5 | 6.0 | 0.930 | 0.820 | 0.110 | 0.15 | 0.16 | ⊙ 0.01 |
| Example 3 | Toner 3 | 10 | 16.3 | 6.1 | 0.941 | 0.691 | 0.250 | 0.15 | 0.16 | ⊙ 0.01 |
| Example 4 | Toner 4 | 10 | 18.0 | 6.2 | 0.928 | 0.708 | 0.220 | 0.16 | 0.18 | ◯ 0.02 |
| Example 5 | Toner 5 | 10 | 15.0 | 5.9 | 0.930 | 0.741 | 0.189 | 0.14 | 0.15 | ⊙ 0.01 |
| Example 6 | Toner 6 | 0 | 16.7 | 6.0 | 0.933 | 0.723 | 0.210 | 0.14 | 0.18 | Δ 0.04 |
| Example 7 | Toner 7 | 10 | 17.2 | 4.9 | 0.935 | 0.785 | 0.150 | 0.14 | 0.15 | ⊙ 0.01 |
| Example 8 | Toner 8 | 10 | 15.3 | 7.0 | 0.900 | 0.705 | 0.195 | 0.16 | 0.17 | ⊙ 0.01 |
| Example 9 | Toner 9 | 10 | 14.8 | 5.9 | 0.933 | 0.725 | 0.208 | 0.16 | 0.19 | ◯ 0.03 |
| Example 10 | Toner 10 | 10 | 16.4 | 6.1 | 0.935 | 0.723 | 0.212 | 0.14 | 0.14 | ⊙ 0.00 |
| Comparative | Toner 11 | 10 | 16.0 | 6.0 | 0.931 | 0.826 | 0.105 | 0.15 | 0.22 | X 0.07 |
| Example 1 | | | | | | | | | | |
| Comparative | Toner 12 | 10 | 17.5 | 6.1 | 0.941 | 0.681 | 0.260 | 0.15 | 0.21 | X 0.06 |
| Example 2 | | | | | | | | | | |
| Comparative | Toner 13 | 10 | 18.5 | 6.2 | 0.935 | 0.725 | 0.210 | 0.17 | 0.23 | X 0.06 |
| Example 3 | | | | | | | | | | |

Remark) Cpes: crystalline polyester resin

From the results shown in Table 1, it was found that the images formed using the toners of Examples 1 to 10 had excellent granularity, and deterioration of the image quality did not easily occur even after a continuous use. Particularly, in Examples 1 to 5 and 7 to 10 in which a toner containing a crystalline polyester resin was used, the deterioration of image quality after a continuous use occurred to a smaller extent. Furthermore, in the toner of Example 10 in which silica particles having a predetermined particle diameter produced by a sol-gel method was used as an external additive, deterioration of image quality was further ameliorated.

On the other hand, in the images formed using the toner of Comparative Example 1 in which the value of AR(L)−AR(H) was smaller than 0.110, or the toner of Comparative Example 2 in which the value was larger than 0.250, the image quality was deteriorated after continuous printing for a long time period. Furthermore, in the toner of Comparative Example 3 in which the coefficient of variation of volume particle size distribution of the toner was more than 18%, it was found that the initial image quality was not satisfactory, and deterioration of image quality after continuous printing was also significant.

What is claimed is:

1. An electrostatic charge image developing toner, comprising at least a binder resin, a colorant, and a mold release agent,
wherein a coefficient of variation of volume particle size distribution of the toner particles is 18% or less, and
in a particle shape distribution analysis made using a flow type particle image analyzer,
when an equivalent circle average particle diameter of the toner particles is designated as D (μm), an average aspect ratio of toner particles having an equivalent circle particle diameter in the range of (D−3) to (D−2) (μm) is designated as AR(L), and an average aspect ratio of toner particles having an equivalent circle particle diameter in the range of (D+3) to (D+4) (μm) is designated as AR(H), the relationship represented by the following Expression (1) is satisfied.
[Expression 1]
0.110≦AR(L)−AR(H)≦0.250 (1)

2. The electrostatic charge image developing toner according to claim 1, wherein the binder resin comprises a crystalline polyester resin.

3. The electrostatic charge image developing toner according to claim 1, wherein the coefficient of variation of volume particle size distribution of the toner particles is 15% to 18%.

4. The electrostatic charge image developing toner according to claim 1, wherein the binder resin comprises a styrene-acrylic resin.

5. The electrostatic charge image developing toner according to claim 1, wherein the toner particles further comprise silica particles produced by a sol-gel method as an external additive, and a number averaged primary particle diameter of the silica particles is 70 nm to 200 nm.

6. The electrostatic charge image developing toner according to claim 1, wherein the relationship represented by the following Expression (2) is satisfied.
[Expression 2]
0.150≦AR(L)−AR(H)≦0.215 (2)

7. The electrostatic charge image developing toner according to claim 1, wherein the equivalent circle average particle diameter of the toner particles is from 5 μm to 8 μm.

8. The electrostatic charge image developing toner according to claim 1, wherein an average circularity of the toner particles is 0.970 or higher.

9. The electrostatic charge image developing toner according to claim 1, wherein the binder resin comprises an amorphous polyester resin.

10. The electrostatic charge image developing toner according to claim 1, wherein the binder resin comprises a hybrid amorphous polyester resin modified by a styrene-acrylic resin.

11. The electrostatic charge image developing toner according to claim 1, wherein the binder resin comprises a crystalline polyester resin at a proportion of from 1% by mass to 20% by mass in the binder resin components.

12. A method for producing an electrostatic charge image developing toner, comprising subjecting at least a binder resin fine particle dispersion containing a binder resin and a colorant particle dispersion containing a colorant, to aggregation and fusion in an aqueous medium in the presence of a sodium alkyl diphenyl ether disulfonate.

13. The method for producing an electrostatic charge image developing toner according to claim 12, wherein the sodium alkyl diphenyl ether disulfonate is sodium dodecyl diphenyl ether disulfonate or sodium nonyl diphenyl ether disulfonate.

14. The method for producing an electrostatic charge image developing toner according to claim 12, wherein at least the binder resin fine particle dispersion containing a binder resin and the colorant particle dispersion containing a colorant are subjected to aggregation and fusion in the aqueous medium in the presence of the sodium alkyl diphenyl ether disulfonate in an amount converted to a solid content of from 0.2% by mass to 1.8% by mass relative to 100% by mass of the total amount of the binder resin.

15. The method for producing an electrostatic charge image developing toner according to claim 12, wherein at least the binder resin fine particle dispersion containing a binder resin and the colorant particle dispersion containing a colorant are subjected to aggregation and fusion in the aqueous medium in the presence of the sodium alkyl diphenyl ether disulfonate in an amount converted to a solid content of from 0.5% by mass to 1.5% by mass relative to 100% by mass of the total amount of the binder resin.
